(19) United States
(12) Patent Application Publication
(10) Pub. No.: US 2012/0112473 A1
(43) Pub. Date: May 10, 2012

(54) Solar desalination system with reciprocating solar engine pumps

(75) Inventor: Kenneth P. Glynn, Flemington, NJ (US)

(73) Assignee: Kenergy Scientific, Inc.

(21) Appl. No.: 13/374,150

(22) Filed: Dec. 14, 2011

Related U.S. Application Data
(63) Continuation-in-part of application No. 12/387,430, filed on May 1, 2009.
Application No. 12/387,430 is a continuation-in-part of application No. 12/319,248, filed on Jan. 5, 2009.
Application No. 12/319,248 is a continuation-in-part of application No. 12/321,402, filed on Jan. 20, 2009, now Pat. No. 8,113,193.
Application No. 12/321,402 is a continuation-in-part of application No. 12/383,353, filed on Mar. 23, 2009.

(51) Int. Cl. H02K 7/18

(52) U.S. Cl. 290/1 R

(57) ABSTRACT

A solar desalination system includes a solar furnace for receiving seawater into a vessel and concentrating sunlight on the vessel to heat that water using solar energy to create desalinated steam. Water is input into the furnace via a pump that is powered by a reciprocating solar engine. The reciprocating solar engine includes a seesawing platform with a closed system of two or more connected containers thereon. Solar heating causes a fluid to move from one container to another causing the platform to reciprocally rotate through a predetermined arc, creating energy that can be harnessed. A riser pipe extending upwardly from the solar furnace carries steam to an electric power-producing steam turbine generator where the steam generates electricity. A drop pipe extending downwardly from the steam turbine generator carries desalinated water to an electric power-producing hydroturbine generator where the water generates electricity and is then removed for subsequent use.

### CROSS-REFERENCE TO RELATED APPLICATIONS

This application is a continuation-in-part of the following copending United States Applications by the same inventors herein: Ser. No. 12/387,430, filed on May 1, 2009, titled “Solar Desalination System”; Ser. No. 12/319,248, filed on Jan. 5, 2009, titled “Reciprocating Solar Engine”; Ser. No. 12/321,402, filed on Jan. 20, 2009, titled “Reciprocating Solar Engine with Attached Solar Windows”; and Ser. No. 12/383,353, filed on Mar. 23, 2009, titled “Reciprocating Solar Engine with Solar Reflectors.”

### BACKGROUND OF INVENTION

a. Field of Invention

The invention relates generally to systems that provide for the conversion of salt water to desalinated water and for the generation of electric power. More specifically, the present invention relates to systems that utilize reciprocating solar engine pumps to pump saline water to a solar evaporator where solar energy is used to separate water from salt in saline water and the resulting evaporative gases are used to effectively generate electric power.

b. Description of Related Art

The following patents are representative of the field pertaining to the present invention:

U.S. Pat. No. 6,786,045 to Letovsky describes engine technologies for power generation and work applications. The engines transform sunlight, heat, or cold, directly into mechanical force. The invention uses a focusing means to apply temperature differentials to a thermally reactive material retained in moveable housings. Said thermally reactive material is mounted in contact with a bearing element configured to apply directional force to said thermally reactive material surface as it changes shape in response to said applied temperature differentials.

U.S. Pat. No. 5,727,379 to Cohn describes an electric power generation system that combines a gas turbine generator with a solar power plant and utilizes the gas turbine exhaust for steam superheating and feed water heating only. The solar heater is only utilized for boiling or evaporation of feed water into steam, the feed water having previously been heated by a downstream portion of the turbine exhaust. In order to balance the disparity between the specific heats of water and steam to thus optimize the system, the steam is superheated by and upstream portion of the turbine exhaust to first drive a high pressure steam turbine and then reheated by the same exhaust over the same temperature range to drive a low pressure steam turbine.

U.S. Pat. No. 5,431,149 to Fossum et al. describes a solar energy collector comprising a plurality of heat absorbing modules formed by deforming two plates into intimate contact with parallel metallic pipes disposed intermediate the plates. The plates are secured together by rivets which are spaced along and traverse the deformed portions of the plates, thus providing a spring section to absorb unequal expansion of the plates and the fluid conducting pipes. The uppermost surface of the pair of plates is provided with a black body coating to emit infrared radiation when sunlight is incident thereon. A glazing is provided over such black body surface to freely transmit incident light to the black body surface but to reflect infrared heat energy emitted by the black body surface. Water or other heat transfer liquid flowing through the pipes is maintained at a sufficiently high pressure to produce a turbulent flow through the pipes to increase the efficiency of the heat transfer. Any size unit can be fabricated by assembling the modules in side by side and/or end to end relationship. Preferably, the collector encompasses horizontally parallel pipes with the inlet and outlet of the collector being on the same side.

U.S. Pat. No. 5,405,503 to Simpson et al. describes a process and apparatus for desalinating seawater for brine and purifying water which contains minerals, salts, and other dissolved solids while simultaneously generating power. The salinous water is heated in a boiler to form steam and a concentrated brine. The concentrated brine is removed from the boiler, the steam produced in the boiler is washed with fresh water to remove trace salts and inorganic materials, and water bearing trace salts and inorganic materials are returned to the boiler. The washed steam is expanded across a turbine to generate electrical or mechanical power which is utilized as a product. The steam exhausted from the turbine is collected and condensed, and one portion of the condensed water is utilized as a fresh water product and another portion of the condensed water is used as the wash water to wash the steam produced in the boiler. Energy efficiency is improved by heat exchanging the hot concentrated brine against the salinous feed water or by flashing the brine to produce steam. Boiler scaling and corrosion may be controlled by feed water pretreatment. By utilizing distillation combined with power generation, demand for fresh water and power can be satisfied simultaneously.

U.S. Pat. No. 4,628,142 to Hashizume describes a solar self-tracking mechanism for continuously tracking the movement of the sun with time which comprises a solar radiant energy receiver secured to a base set on the ground and rotatable about a rotating shaft which extends horizontally in an east-west direction and a plurality of compound parabolic concentrators secured to both longitudinal edges of the solar receiving mechanism in parallel to the rotating shaft. The sun energy concentrated on suitable means such as shape memory alloy coil or solar cell module located at a position coincident with the focal line of the compound parabolic concentrator is transferred to a mechanism for driving the rotating shaft of the solar radiant energy receiver thereby to rotate the same and continuously obtain the solar radiant energy.

U.S. Pat. No. 4,476,854 to Stephen C. Baer describes an apparatus for tracking the sun which reorients itself immediately in the absence of sunlight. Large and small cannisters are provided at the respective ends of a pivotable frame. When the sun is not normal to the plane containing the cannister, the near cannister is shaded from direct sunlight and the far cannister is exposed. A conduit is provided between the cannisters, and a quantity of volatile fluid is located in the cannisters, and conduit. The liquid volume of the volatile fluid is greater than that of the small cannister plus the conduit, but less than the volume of the large cannister. A gas spring fluid is located in the large cannister, which has a vapor pressure sufficient to force the volatile fluid into the small cannister in the absence of sunlight on the east cannister.

U.S. Pat. No. 4,323,052 to Stark describes solar energy systems that provide for the distillation of liquids and/or the production of electricity using photovoltaic cells. Apparatus are disclosed which include an undulated system for conducting the liquid to be distilled, a linear lens disposed to concentrate solar energy on or below the undulated system, and a conduit transparent to visible light interposed between the undulated system and the linear lens. A cooling fluid is supplied to the conduit for assisting condensation of liquid evaporated from the undulated system on the lower wall of the conduit. The condensed liquid, the condensate and a concentrate of the liquid being distilled are collected. An array of photovoltaic cells may be disposed in the undulated system at a location of the concentration of solar energy to thereby provide for both distillation of the liquid and generation of electricity. Instead of an undulated system for conducting the liquid to be distilled, in one embodiment, a first transparent tube is disposed in a second transparent tube. The liquid to be distilled evaporates in the first transparent tube and is condensed on the upper wall thereof which has an outer surface in contact with the cooling fluid. If desired, photovoltaic cells may also be disposed in the first transparent tube. In another disclosed embodiment, a collector comprises tubes one disposed in the other with a fluid being circulated through each tube and insulation surrounding the lower portion of the tubes. Photovoltaic cells may be disposed in the innermost tube which is transparent.

U.S. Pat. No. 4,275,712 to Stephen C. Baer describes a device for rotating a collector of solar energy in such a way as to keep it constantly oriented during the day in the best direction for interception of radiation and for returning it to a position from which it will begin collecting radiation again in the morning. Whereas a previously disclosed device for automatic return to morning position relies upon changing the rate of heat loss from the surfaces of the interconnected canisters which power it, the present invention removes the heat-collecting surfaces whose differential heating by the west-moving sun controls the tilting of the collector from the canisters themselves to plates located below and on sides opposite the canisters served so as to give these surfaces a larger view of the sky and enable them to find the sun from almost any position.

U.S. Pat. No. 4,203,295 to Siegel describes a reversible differential temperature engine especially adapted to convert solar thermal energy into mechanical energy in the absence of gravity in space. This is achieved by reversible means which allow the alternate function of each chamber of the differential temperature engine as an evaporator and condensor chamber.

U.S. Pat. No. 4,194,492 to Gerald J. Tremblay describes a solar fluid heater that has a frame and a solar collector for collecting and concentrating solar energy movably mounted on the frame. An inclination adjustment system is attached for rotating the solar collector for different inclinations of the earth relative to the sun, and a solar tracking system moves the solar collector in a different direction on the frame during daylight hours responsive to the flow of liquid from a reservoir mounted thereon to track the sun during daylight hours.

U.S. Pat. No. 4,175,391 to Stephen Baer describes an apparatus for causing a solar energy collector to constantly follow the sun by using solar radiant energy to differentially heat fluid-containing reservoirs to cause differential vaporization and shifting of fluid to rotate the apparatus. Automatic morning orientation is included by providing the easterly reservoir with a faster rate of cooling than the westerly one thereby causing shift of fluid from westerly to easterly after sunset resulting in inclination toward the east by sunrise.

U.S. Pat. No. 4,132,223 to E. Garland Reddell describes a pivotally mounted solar energy collector is maintained oriented towards the sun by creating a continuing imbalance of the collector about its pivotal axis resulting in pivotal movement of the collector to track the sun. The imbalance is achieved by regulating the flow of a pumped fluid from a container located at one side of the collector to a container located at another side of the collector. Pump, timing and energizing means are included to control the flow rate of the fluid.

U.S. Pat. No. 4,110,172 to Spears, Jr. describes a water-containing pond for collecting solar energy for utilization in a process for recovering potable water from non-potable water and/or for the generation of power. The solar pond in designed to increase the quantity and efficiency of water evaporation, from heated pond water, into a heated flowing air stream. Construction in such that there is afforded an increase in the absorptivity/emissivity (a/e) ratio with respect to the incidence of solar radiation.

U.S. Pat. No. 4,079,249 to Kenneth P. Glynn describes a motor apparatus described for orientating solar responsive devices. The motor apparatus is solar energy operated and comprises a plurality of containers connected in closed systems having fluid therein, support means for the containers including rotatable parts, and a solar window-containing component which permits solar energy to strike surfaces of the containers so as to change the distribution of fluid in the systems to cause the rotatable parts, and thus an attached solar responsive device, to rotate, e.g., in an arc so as to follow the sun.

U.S. Pat. No. 3,846,984 to Siegel describes a unit pair of chambers with means of obtaining a temperature differential between the chambers, The chambers contain a low boiling point fluid defining a liquid phase and a vapor phase. By closing and opening of a communication between vapor phases of the chambers, cyclic differences in vapor pressure between the chambers is obtained. At least one of said chambers is provided with a moveable wall portion which responds to changes in the vapor pressure in the chamber. This movable wall also controls the opening between vapor phases of chambers. Controls and conduits are provided to return the condensed liquid from cold to warm chamber, and the return of moveable portion to its starting position. By means of proper linkages, the moveable wall is translated into useful work.

U.S. Pat. No. 3,635,015 to Samuels describes a radiant energy apparatus which automatically orients itself relative to the radiation source. A sensing panel having an absorbing surface to be exposed generally toward the source and a radiating surface shielded from the source but thermally connected to the absorbing surface is variably covered by a sensor shutter which is controlled by passive, bimetallic, radiation-direction-sensitive means. A power drive unit including a thermally expansive fluid-filled cylinder and piston connected therewith is mounted on the panel and drives an orienting mechanism in response to the temperature of the sensing panel as determined by its angle of exposure toward the source, the degree of its shielding therefrom as by the sensing shutter, and the rate of thermal radiation from the sensing panel. The power drive element may also drive the second shutter for variable shielding of the panel for additional feedback control of the system.

U.S. Pat. No. 3,451,220 to Buscemi describes a combined closed-cycle condensable vapor motivated turbine power plant for generating electrical power and a liquid distillation plant for desalinating sea water, wherein the brine or feed liquid heater for the distillation plant is energized by exhaust steam from a back pressure turbine. The back pressure turbine is connected in tandem with one or more condensing turbines and the back pressure turbine and condensing turbines are fed motive vapor in parallel by a common conduit, thereby providing flexibility in control of the electrical and water production rates for varying demand. The control includes an arrangement for controlling the pressure of the heating vapor admitted to the brine heater regardless of load demand on the turbines, during periods in which water distillation requirements are constant, and in which the hot exhaust vapor supply from the back pressure turbine to the brine heater may be diverted during no load requirements on the distillation plant. The invention provides a combined plant of large output capability in which the hot vapor for motivating the turbines and the brine heater may be advantageously generated by a single nuclear reactor.

U.S. Pat. No. 3,342,697 to Hammond describes a device that constitutes a multilevel plural stage evaporator for the flash distillation of saline water, economically suited for large volume purification systems. Brine heated by a primary heat source is fed to a series of multilevel trays at one end of the evaporator shell and flows through successive stages defined by compartments formed in the common chamber of the evaporator shell at progressively lower pressures to flash and produce vapor. Condenser coils on either side of the tier of trays condense the vapor which is then collected in common troughs at the base of the shell. The feed is circulated through the condenser coils countercurrent to brine flow in the trays to serve the dual purpose of condensing the vapors and preheating the feed.

U.S. Pat. No. 3,029,806 to Okuda describes a solar hot water heater. Of the hot water heater that are installed in the open and by utilizing the solar heat rays hot water is obtained, that is, a so-called solar hot water heater, the invention relates in particular to a novel solar hot water heater in which all of its members are constituted of a soft plastic, such as polyvinyl chloride, in which the special technical problems that arise from the uniqueness of the material used have been solved.

U.S. Pat. No. 2,999,943 to Geer describes a self-orienting heliotropic device which relates to self-orienting positive heliotropic devices and, more particularly, to such devices which are used to orient converters which transform solar energy into electrical, chemical, mechanical, or thermal energy.

U.S. Pat. No. 2,902,028 to Manly describes a solar distillation unit comprising a recessed exteriorly insulated shell, transparent means sealing said recess to form a heating zone, a removable evaporator unit positioned in said heating zone, means positioned above the heating zone for focusing the sun's rays on the surface of said evaporator unit, feed water inlet lines in fluid communication with said heating zone located adjacent each end of said evaporator unit and including means for spraying feed water over the surface of said evaporator unit, means to tiltably mount said unit to respectively raise and lower the ends thereof, valve means operable to supply feed water to the uppermost of said feed lines when the unit is tilted at an angle, means for switching said valve to supply the water to the other of said feed lines when the angle of tilt is reversed, said evaporator unit comprising a plurality of open-ended tubes lying transverse the normal flow of water, adjacent tubes being in close proximity, means for maintaining said tubes in close proximity to form a rigid removable structure, said open-ended tubes being provided with apertures to permit a limited flow of the water cascading over said tubes into the interior thereof, a vapor outlet from the heating zone and means positioned between said heating zone and said vapor outlet for preventing flow of feed water from said heating zone into said vapor outlet.

U.S. Pat. No. 2,636,129 to Agnew describes a solar engine, a reservoir, a basin for receiving liquid from the reservoir, a differential pressure conduit extending from the reservoir to the basin for passing liquid into the latter, means in said conduit for removing free air in the liquid passing therethrough, a transparent dome for the basin and comprising a plurality of flat sheets for transmitting solar rays to evaporate the liquid in the basin, an upwardly directed duct extending from said dome to conduct the evaporated liquid to a level above and at a substantially lower atmospheric pressure than that of both the reservoir and the basin, a condenser at the upper end of the duct to condense said vapors, means for removing free air from the condenser, a storage reservoir elevated above the first-mentioned reservoir, and a differential pressure conduit leading from the condenser to the storage reservoir.

United States Patent Application Publication No. 2010/0180594 A1 to Glynn describes a reciprocating solar engine that includes a) a seesawing platform having a central fulcrum support upon which the platform is moveably positioned to reciprocally rotate through a predetermined arc b) a first solar heat-receiving closed container located on the platform on one side of the support and a second solar heat-receiving closed container located on the platform on a second side of the support; c) a connecting tube connecting the first container and the second container; d) a fluid contained within at least one of the first and the second container, the fluid being evaporable from solar heat and condensable from shading from solar heat; e) a roof above and connected to the platform, having at least one window of which is located above the first container and at least one window of above the second container; f) shuttering devices connected to the roof and movable so that one window is closed while the other is open and vice versa; and, g) shutter device controls functionally connected to the shutter device and the platform such that the shutter device controls activate the shutter devices to a first rest position when the second solar heat-receiving closed container is at its arc base, and to the second rest position when the first solar heat-receiving closed container is at its arc base.

United States Patent Application Publication No. 2010/0170497 A1 to Glynn describes a reciprocating solar engine includes a) a seesawing platform having a central fulcrum support upon which the platform is moveably positioned to reciprocally rotate through a predetermined arc b) a first solar heat-receiving closed container located on the platform on one side of the support and a second solar heat-receiving closed container located on the platform on a second side of the support; c) a connecting tube connecting the first container and the second container; d) a fluid contained within at least, one of the first and the second container, the fluid being evaporable from solar heat and condensable from shading from solar heat; e) a roof above the platform, having at least one window of which is located above the first container and at least one window of above the second container; f) shuttering devices connected to the roof and movable so that one window is closed while the other is open and vice versa; and, g) shutter device controls functionally connected to the shutter device and the platform such that the shutter device controls activate the shutter devices to a first rest position when the second solar heat-receiving closed container is at its arc base, and to the second rest position when the first solar heat-receiving closed container is at its arc base.

United States Patent Application Publication No. 2003/0192315 to Corcoran describes a method and apparatus for producing energy, provided for generating renewable energy. Captive compressed fluid cycles between two coupled containers through a motive power source. The captive compressed fluid flows between the containers in response to a difference in the pressure of the compressed fluid within the first container compared to the pressure of the compressed fluid within the second container. This pressure differential develops as the compressed fluid within the first container experiences a temperature change of a differing percentage magnitude or direction than the compressed fluid within the second container over the same period of time. The differing percentage temperature fluctuations result as the containers are provided dissimilar exposure to natural renewable or man-made energy sources or are insulated therefrom. A continuous supply of additional compressed fluid is not required, nor is fluid routinely vented to the atmosphere.

United States Patent Application Publication No. 2002/0092761 A1 to Nagler describes an apparatus for the desalination or purification of water comprising a non-solid vessel having a bottom defining an opening, the vessel capable of being partially submerged below the surface of a body of water, a pan located within the vessel, the pan being flexibly connected to the inner wall of the vessel and being located beneath the surface of the water, a lens fixably connected to the top of the vessel, wherein the lens is focused beneath the surface of the water and above the surface of the pan means for varying the orientation of the vessel in accordance with the location of the sun, and means for condensing steam generated in the non-solid vessel, whereby steam generated in the non-solid vessel is condensed outside of the non-solid vessel. A method for the desalination or purification of water comprises the steps of containing a body of water within a vessel, the vessel having a lens fixably attached at the top and bottom defining an opening, located a pan just below the surface of the water, focusing the lens just beneath the surface of the water and just above he bottom surface of the pan, condensing water vapor, re-filling the vessel with water as the water is converted to steam, and periodically re-orienting the vessel in a manner that tracks movement of the sun.

Notwithstanding the prior art, the present invention is neither taught nor rendered obvious thereby.

### SUMMARY OF INVENTION

The present invention is a solar desalination system for creation of desalinated water from seawater that also produces electricity. The present invention system includes: a) a solar furnace unit, including a vessel for receiving and evaporating seawater to create desalinated steam, and a solar energy concentrator positioned adjacent the vessel to concentrate solar energy to the vessel; b) input means for feeding seawater to the vessel; c) brine output means for removal of brine water bottoms from the vessel; d) a riser pipe having a top and a bottom and being connected at its bottom to and extending upwardly from the vessel for transporting steam from the vessel, the riser pipe top positioned at a predetermined vertical height from the vessel; e) an electric power-producing steam turbine generator positioned at a predetermined vertical height from the vessel, and connected to the top of the riser pipe for production of electric power with steam from the vessel; f) a drop pipe having a top and a bottom, and being connected at its top to the steam turbine generator for removal of desalinated water from the steam turbine generator; g) an electric power-producing hydroturbine generator connected to the bottom of the drop pipe for production of electric power with desalinated water from the steam turbine generator; and, h) egress means for removal of desalinated water from the hydroturbine generator for subsequent use; wherein the input means for feeding seawater into the vessel includes: 1) at least one pump adapted to feed seawater into the vessel, having a drive means selected from the group consisting of mechanical drive means, direct drive electrical means, and electrical storage means; 2) a seesawing platform having a central fulcrum support upon which the platform is moveably positioned to reciprocally rotate through a predetermined arc, the predetermined arc having a bottom, the bottom being the arc base; 3) a first solar heat-receiving closed container located on the platform on a first side of the central fulcrum support and a second solar heat-receiving closed container located on the platform on a second side of the central fulcrum support and opposite the first side; 4) at least one solar reflector located adjacent the first solar heat-receiving closed container and positioned so as to reflect solar energy from the reflector to the first solar heat-receiving closed container and at least one solar reflector adjacent the second solar heat-receiving closed container and positioned so as to reflect solar energy from the reflector to the second solar heat-receiving closed container; 5) a connecting tube, connected to the first solar heat-receiving closed container and to the second solar heat-receiving closed container; 6) a fluid contained within at least one of the first solar heat-receiving closed container and the second solar heat-receiving closed container, said fluid being evaporable from solar heat and condensable from shading from solar heat; 7) a roof located above the platform, the roof having at least two windows, at least one window of which is located above the first solar heat-receiving closed container and at least one window of which is located above the second solar heat-receiving closed container; 8) shutter means connected to the roof and movably related to the at least two windows and functionally connected thereto, the shutter means having a first rest position and a second rest position, wherein in the first rest position, the at least one window above the first solar heat-receiving closed container is open and the at least one window above the second solar heat-receiving closed container is closed, and wherein in the second rest position, the at least one window above the first solar heat-receiving closed container is closed and the at least one window above the second heat-receiving closed container is open; 9) shutter control means functionally connected to the shutter means and functionally connected to the platform such that the shutter control means activates the shutter to the first rest position when the second solar heat-receiving closed container is at its arc base, and to the second rest position when the first solar heat-receiving closed container/is at its arc base; and 10) pump drive means functionally connected to the seesawing platform, the pump drive means selected from the group consisting of mechanical means, direct drive electrical means, and electrical storage means.

In some preferred embodiments of the present invention solar desalination system, the riser pipe top and the steam turbine generator are at least 30 meters higher than the vessel.

In some preferred embodiments of the present invention solar desalination system, the solar energy concentrator is selected from the group consisting of a linear parabolic solar concentrator, a parabloid solar concentrator and plural mirror solar concentrator.

In some preferred embodiments of the present invention solar desalination system, the solar energy concentrator is moveably mounted, and includes solar tracking means adapted to move the solar energy concentrator to follow the sun.

In some preferred embodiments of the present invention solar desalination system, the system further includes: i) auxiliary heating means proximate the vessel and adapted to heat the vessel to assist the solar furnace. In some preferred embodiments of the present invention solar desalination system, the auxiliary heating means for the vessel is adapted to operate when solar power is insufficient to evaporate seawater in the vessel. In some preferred embodiments of the present invention solar desalination system, the auxiliary heating means this is an electric heating means that is powered from at least one of the generators.

In some preferred embodiments of the present invention solar desalination system, the riser pipe includes at least one booster heater. In some preferred embodiments of the present invention solar desalination system, the at least one booster heater is selected from the group consisting of a solar heater, a heat exchange heater, an electric heater and combinations thereof.

In some preferred embodiments of the present invention solar desalination system, the egress means includes heat exchange cooling means.

In some preferred embodiments of the present invention solar desalination system, the system further includes an elevated storage tank connected to and downstream from the steam turbine generator and connected to the drop pipe, adapted for storage and controlled release of desalinated water to provide water and power when the solar furnace unit is not producing water and electricity.

In some preferred embodiments of the present invention solar desalination system, the shutter means is selected from the group consisting of a single sliding door, doors, shutters, screens and shades.

In some preferred embodiments of the present invention solar desalination system, the roof is a rectangular shaped roof from a top view.

In some preferred embodiments of the present invention solar desalination system, the shutter controls means is selected from the group consisting of motor drive control means, mechanical control means, hydraulic control means and pneumatic control means.

In some preferred embodiments of the present invention solar desalination system, the first solar heat-receiving closed container and the second solar heat-receiving closed container are at least partially transparent containers.

In some preferred embodiments of the present invention solar desalination system, the at least partially transparent containers have transparent tops and solar heat-absorbing bottoms.

In some preferred embodiments of the present invention solar desalination system, the first solar heat-receiving closed container and the second solar heat-receiving closed container are selected from the group consisting of glass, metal, plastic, and combinations thereof.

In some preferred embodiments of the present invention, the solar desalination system further includes a shaft connected to the platform proximate its center and on its axis of rotation to function as an arcuate reciprocating drive shaft.

In some preferred embodiments of the present invention solar desalination system, the at least two windows contain solar energy concentrating magnifying lenses.

In yet other preferred embodiments of the present invention solar desalination system, the system includes: a) a solar furnace unit, including a vessel for receiving and evaporating seawater to create desalinated steam, and a solar energy concentrator positioned adjacent the vessel to concentrate solar energy to the vessel; b) input means for feeding seawater to the vessel; c) brine output means for removal of brine water bottoms from the vessel; d) a riser pipe having a top and a bottom and being connected at its bottom to and extending upwardly from the vessel for transporting steam from the vessel, the riser pipe top positioned at a predetermined vertical height from the vessel; e) an electric power-producing steam turbine generator positioned at a predetermined vertical height from the vessel, and connected to the top of the riser pipe for production of electric power with steam from the vessel; f) a drop pipe having a top and a bottom, and being connected at its top to the steam turbine generator for removal of desalinated water from the steam turbine generator; g) an electric power-producing hydroturbine generator connected to the bottom of the drop pipe for production of electric power with desalinated water from the steam turbine generator; and, h) egress means for removal of desalinated water from the hydroturbine generator for subsequent use; wherein the input means for feeding seawater into the vessel includes: 1) at least one pump adapted to feed seawater into the vessel, having a drive means selected from the group consisting of mechanical drive means, direct drive electrical means, and electrical storage means; 2) a seesawing platform having a central fulcrum support upon which the platform is moveably positioned to reciprocally rotate through a predetermined arc, the predetermined arc having a bottom, the bottom being the arc base; 3) a first solar heat-receiving closed container located on the platform on a first side of the central fulcrum support and a second solar heat-receiving closed container located on the platform on a second side of the central fulcrum support and opposite the first side; 4) at least one solar reflector located adjacent the first solar heat-receiving closed container and positioned so as to reflect solar energy from the reflector to the first solar heat-receiving closed container and at least one solar reflector adjacent the second solar heat-receiving closed container and positioned so as to reflect solar energy from the reflector to the second solar heat-receiving closed container; 5) a connecting tube, connected to the first solar heat-receiving closed container and to the second solar heat-receiving closed container; 6) a fluid contained within at least one of the first solar heat-receiving closed container and the second solar heat-receiving closed container, said fluid being evaporable from solar heat and condensable from shading from solar heat; 7) a housing having side walls and a roof, the housing attached to the platform so as to move therewith, the roof of the housing being located at least above the platform, the roof having at least two window, at least one window of which is located above the first solar heat-receiving closed container and at least one window of which is located above the second solar heat-receiving closed container; 8) shutter means connected to the roof and movably related to the at least two windows and functionally connected thereto, the shutter means having a first position and a second rest position, wherein in the first rest position, the at least one window above the first solar heat-receiving closed container is open and the at least one window above the second solar heat-receiving closed container is closed, and wherein in the second rest position, the at least one window above the first solar heat-receiving closed container is closed and the at least one window above the second heat-receiving closed container is open; 9) shutter control means functionally connected to the shutter means and functionally connected to the platform such that the shutter control means activates the shutter to the first rest position when the second solar heat-receiving closed container is at its arc base, and to the second rest position when the first solar heat-receiving closed container is at its arc base; and 10) pump drive means functionally connected to the seesawing platform, the pump drive means selected from the group consisting of mechanical means, direct drive electrical means, and electrical storage means.

In some preferred embodiments of the present invention solar desalination system, the riser pipe top and the steam turbine generator are at least 30 meters higher than the vessel.

In some preferred embodiments of the present invention solar desalination system, the solar energy concentrator is selected from the group consisting of a linear parabolic solar concentrator, a parabloid solar concentrator and plural mirror solar concentrator.

In some preferred embodiments of the present invention solar desalination system, the solar energy concentrator is moveably mounted, and includes solar tracking means adapted to move the solar energy concentrator to follow the sun.

In some preferred embodiments of the present invention solar desalination system, the system further includes: i) auxiliary heating means proximate the vessel and adapted to heat the vessel to assist the solar furnace. In some preferred embodiments of the present invention solar desalination system, the auxiliary heating means for the vessel is adapted to operate when solar power is insufficient to evaporate seawater in the vessel. In some preferred embodiments of the present invention solar desalination system, the auxiliary heating means this is an electric heating means that is powered from at least one of the generators.

In some preferred embodiments of the present invention solar desalination system, the riser pipe includes at least one booster heater. In some preferred embodiments of the present invention solar desalination system, the at least one booster heater is selected from the group consisting of a solar heater, a heat exchange heater, an electric heater and combinations thereof.

In some preferred embodiments of the present invention solar desalination system, the egress means includes heat exchange cooling means.

In some preferred embodiments of the present invention solar desalination system, the system further includes an elevated storage tank connected to and downstream from the steam turbine generator and connected to the drop pipe, adapted for storage and controlled release of desalinated water to provide water and power when the solar furnace unit is not producing water and electricity.

In some preferred embodiments of the present invention solar desalination system, the shutter means is selected from the group consisting of a single sliding door, doors, shutters, screens and shades.

In some preferred embodiments of the present invention solar desalination system, the roof is a rectangular shaped roof from a top view.

In some preferred embodiments of the present invention solar desalination system, the shutter controls means is selected, from the group consisting of motor drive control means, mechanical control means, hydraulic control means and pneumatic control means.

In some preferred embodiments of the present invention solar desalination system, the first solar heat-receiving closed container and the second solar heat-receiving closed container are at least partially transparent containers.

In some preferred embodiments of the present invention solar desalination system, the at least partially transparent containers have transparent tops and solar heat-absorbing bottoms.

In some preferred embodiments of the present invention solar desalination system, the first solar heat-receiving closed container and the second solar heat-receiving closed container are selected from the group consisting of glass, metal, plastic, and combinations thereof.

In some preferred embodiments of the present invention, the solar desalination system further includes a shaft connected to the platform proximate its center and on its axis of rotation to function as an arcuate reciprocating drive shaft.

In some preferred embodiments of the present invention solar desalination system, the at least two windows contain solar energy concentrating magnifying lenses.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a block diagrammatic representation of some preferred embodiments of the present invention solar desalination system;

FIG. 2 shows details of one preferred embodiment of the present invention solar desalination system with three different types of electric power generation;

FIG. 3 presents a block diagram showing various preferred embodiment options for present invention power generating solar desalination systems;

FIG. 4 illustrates FIG. 1 type solar desalination systems but with elevated water storage to provide for water and power availability at night or otherwise when the solar evaporator is not operating;

FIG. 5 shows the FIG. 2 preferred present invention solar desalination system, but now including water storage with controlled release;

FIG. 6 shows the present invention power generating solar desalination systems of FIG. 1, with steam rise pipe booster heater, optional water storage and optional heat of condensation electric power generation;

FIG. 7 shows a flow diagram for one embodiment of a continuous operation of a present invention solar desalination system;

FIG. 8 illustrates a flow diagram for one embodiment of a batch operation of a present invention solar desalination system;

FIG. 9 is a side cut view of another preferred embodiment of a present invention reciprocating solar engine;

FIGS. 10 through 14 show side cut views of the preferred embodiment of a present invention reciprocating solar engine shown in FIG. 9, in different positions of a reciprocal cycle;

FIG. 15 is a side cut view of another preferred embodiment of a present invention reciprocating solar engine;

FIGS. 16 through 20 show side cut views of the preferred embodiment of a present invention reciprocating solar engine shown in FIG. 15, in different positions of a reciprocal cycle;

FIG. 21 is a side cut view of another preferred embodiment of a present invention reciprocating solar engine with a roof with open supports instead of closed walls;

FIG. 22 is a side cut view of another preferred embodiment of a present invention reciprocating solar engine with a magnifying lens in each window to function as a solar energy concentrator;

FIG. 23 is a side cut view of another preferred embodiment of a present invention reciprocating solar engine with sets of shutters or blinds to function as the window shutter means;

FIG. 24 is a side cut view of another preferred embodiment of a present invention reciprocating solar engine with the device as shown in FIG. 15 but with a gear driving shaft take-off connected to the reciprocating platform at its axis of rotation;

FIG. 25 is a side cut view of another preferred embodiment of a present invention reciprocating solar engine with the device as shown in FIG. 15 but with a reciprocating connector rod to the reciprocating platform away from its axis of rotation;

FIG. 26 is a side cut view of another preferred embodiment of a present invention reciprocating solar engine;

FIG. 27 is a side cut view of another preferred embodiment of a present invention reciprocating solar engine with the device as shown in FIG. 26 but with a gear driving shaft take-off connected to the reciprocating platform at its axis of rotation; and,

FIG. 28 is a side cut view of another preferred embodiment of a present invention reciprocating solar engine with a magnifying lens in each window to function as a solar energy concentrator.

### DETAILED DESCRIPTION OF THE EMBODIMENTS

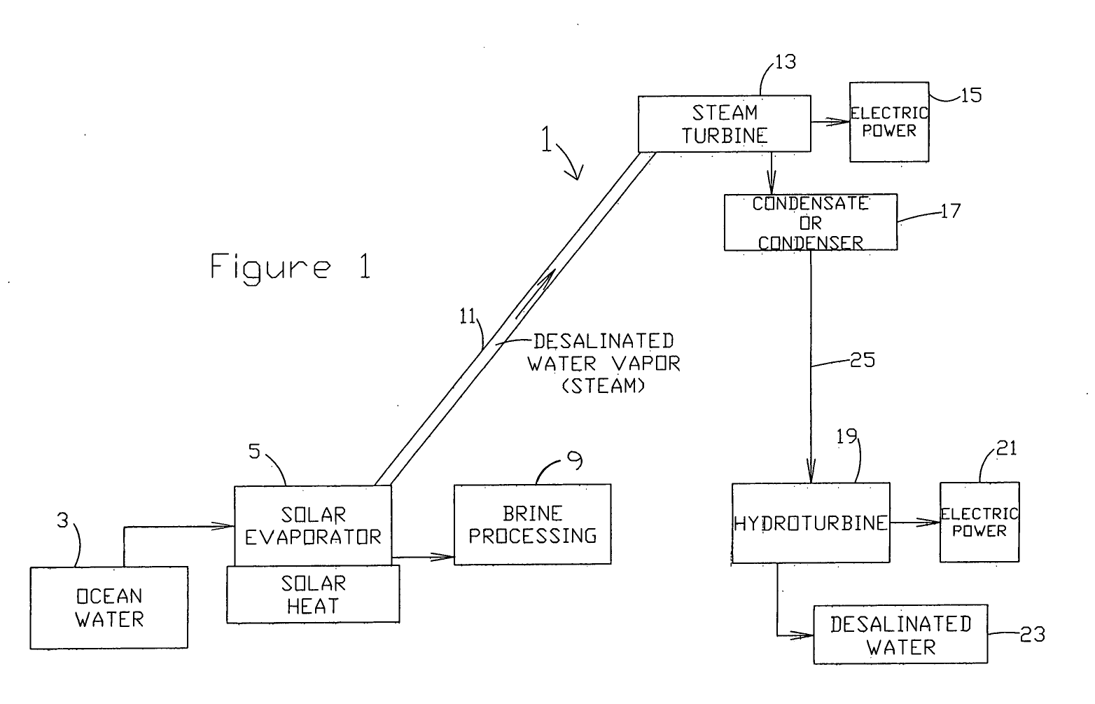

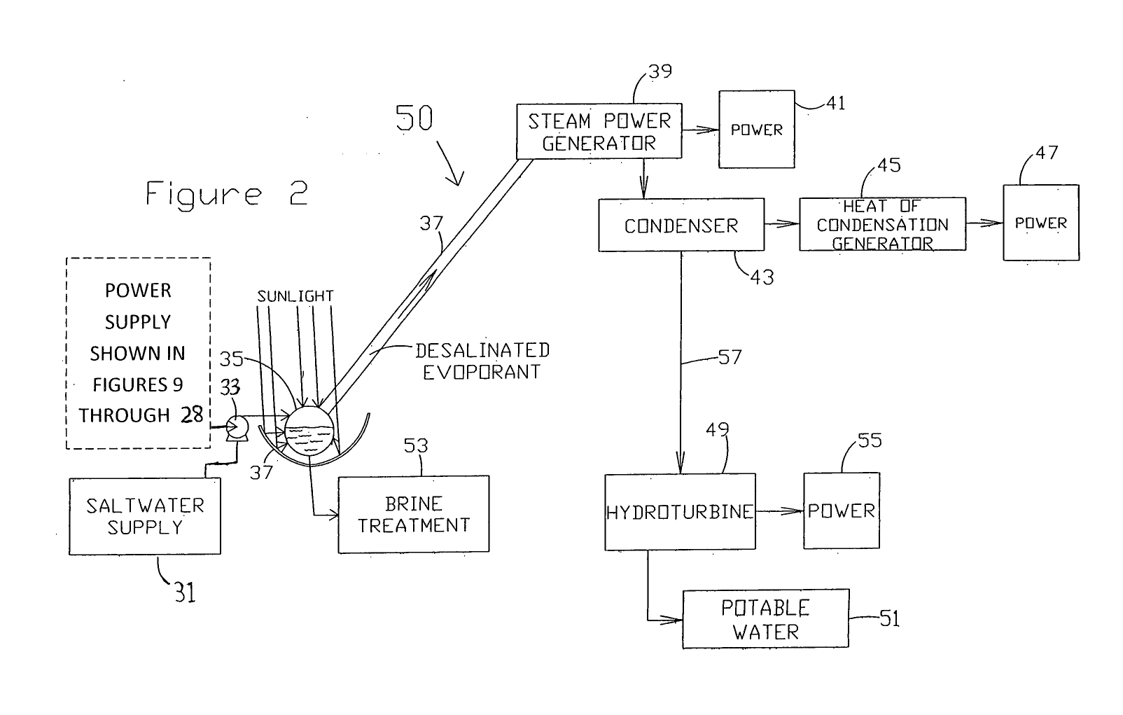

FIG. 1 is a block diagram of some preferred embodiments of a present invention solar desalination system 1. Present invention system 1 includes a supply of salt water, here ocean water 3, that is fed to or pumped (not shown) to solar evaporator 5. Solar evaporator 5 may be any solar evaporator that has been heretofore suggested or taught and thus may be a flat mirror array for reflecting vast areas of sunlight so as to be directed to a container or vessel for evaporating water out of the saline water. Alternatively, it could be a parabolic dish solar concentrator device or any other solar evaporator or furnace. The size of the solar evaporator 5 is dependent upon the ambient temperature and the volume of ocean water (capacity of the vessel) being used. Thus, solar heat 7 provides the evaporator 5 with heat energy to generate desalinated water vapor (steam that moves up riser pipe 11 a predetermined height, e.g., 200 feet), to steam turbine 13. Steam turbine 13 will be installed on a tower, building or other structure or on a natural elevated area such as a hill or cliff. Steam turbine 13 is an electric power 15 generating steam turbine and may be designed to condense the steam to water or to utilize steam and exhaust the steam.

In either case the steam turbine 13 generates electric power 15 and its H₂O effluent exits as condensate or is condensed 17 at or near the predetermined elevated steam turbine 13. Next, the water product that is dropped a predetermined height, and this height establishes a head of water that drives a water turbine. Thus, the desalinated water travels down drop pipe 25 to drive hydroturbine 19 to generate additional electric power 21. The desalinated water 23 may be treated or otherwise used as desired.

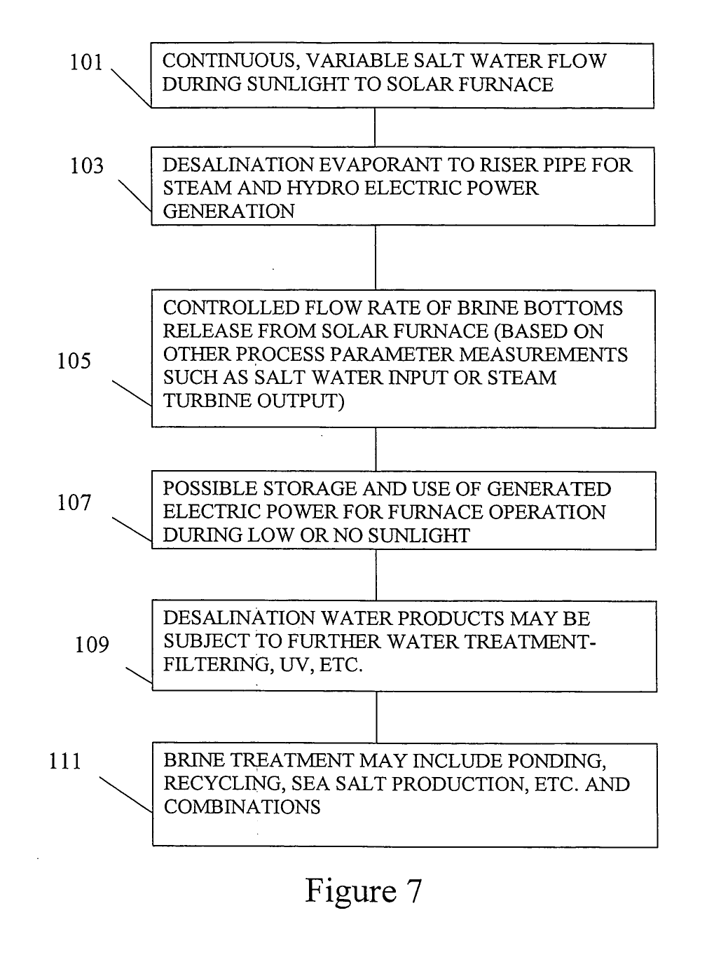

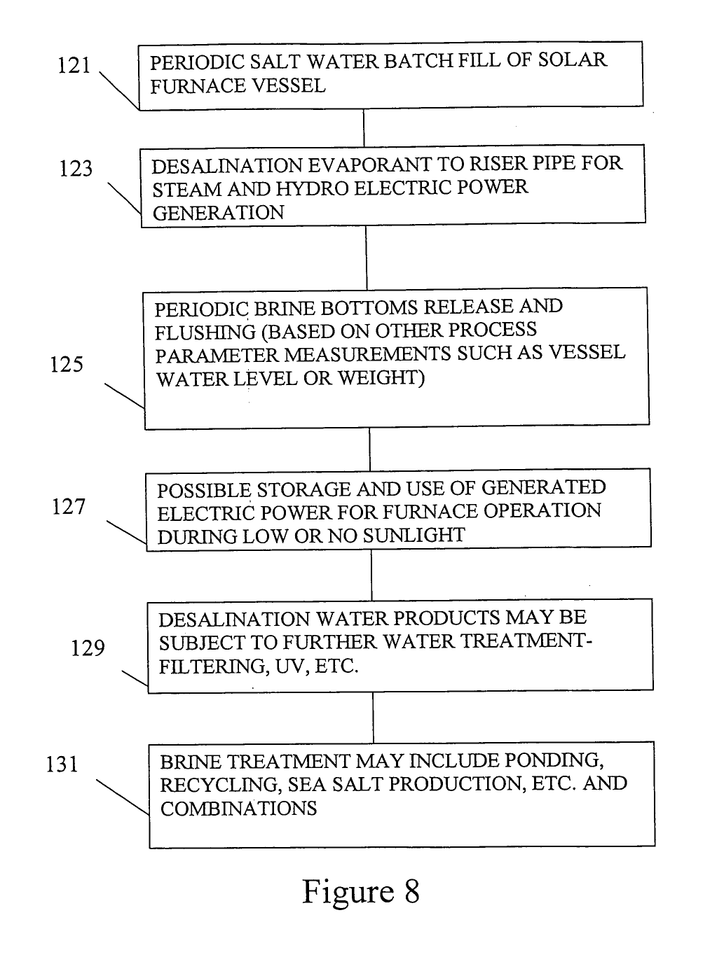

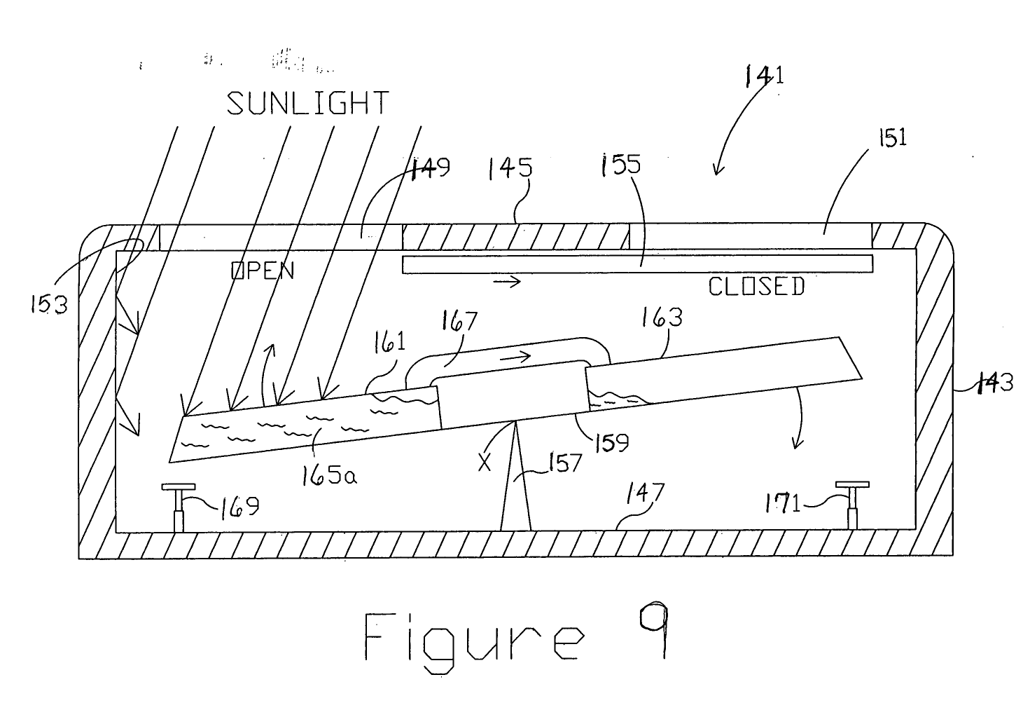

The present invention system could operate on a continuous basis much like tankless water heaters, when there is sufficient sunlight, and appropriate flow valves and controls would be necessary to assure a steady output ratio—for example, 90% tops (desalinated evaporant)/10% bottoms (brine—high density salt water). However, in many cases, the system will operate as a batch process. Details of some embodiments of continuous and batch process of the present invention are discussed below in conjunction with FIGS. 7 and 8.

FIG. 2 illustrates a present invention solar desalination system with three different types of electric power generation. System 50 includes a salt water supply 31 and a delivery pump 33 to move the saline water to the solar furnace (evaporator). In this embodiment, the solar furnace is concentrator 37. It is positioned to concentrate solar energy (sunlight) onto vessel 35. Pump 33 is programmed to follow a sequence, such as, when the saltwater level in vessel 35 is below a certain level, a flush mode will initiate. A valve or other liquid egress control (not shown) will open vessel 35 to brine treatment 53, pump 33 may provide flushing salt water from supply 31 and, after a predetermined time or volume of flow, pump 33 will stop and the liquid egress control will close. Next, pump 33 will activate to pump a predetermined volume (or other predetermined parameter) and fill the vessel 35 to a predetermined level. The solar furnace (concentrator 37) will evaporate desalinated water until the vessel 35 is depleted to a predetermined level, and then the flushing and evaporating phases will be repeated.

When the solar concentrator 37 evaporates the desalinated water into steam (desalinated evaporant), this steam travels up riser pipe 37 to elevated steam generator 39 where the steam generates electric power 41. While still at elevation, the steam is condensed to water at condenser 43, and the heat of condensation (e.g., through heat exchangers) is committed to a heat of condensation electric power generator 45 to produce power 47.

Next, the condensed steam (desalinated water) travels down drop pipe 57 (shown as a vertical pipe, but could be a slanted pipe, as down a slope or hill), to hydroturbine 49 to generate electric power 55, and to produce useable water such as potable water 51.

This FIG. 2 present invention solar desalination system 50 creates power at three different sources—steam, heat of condensation and hydro.

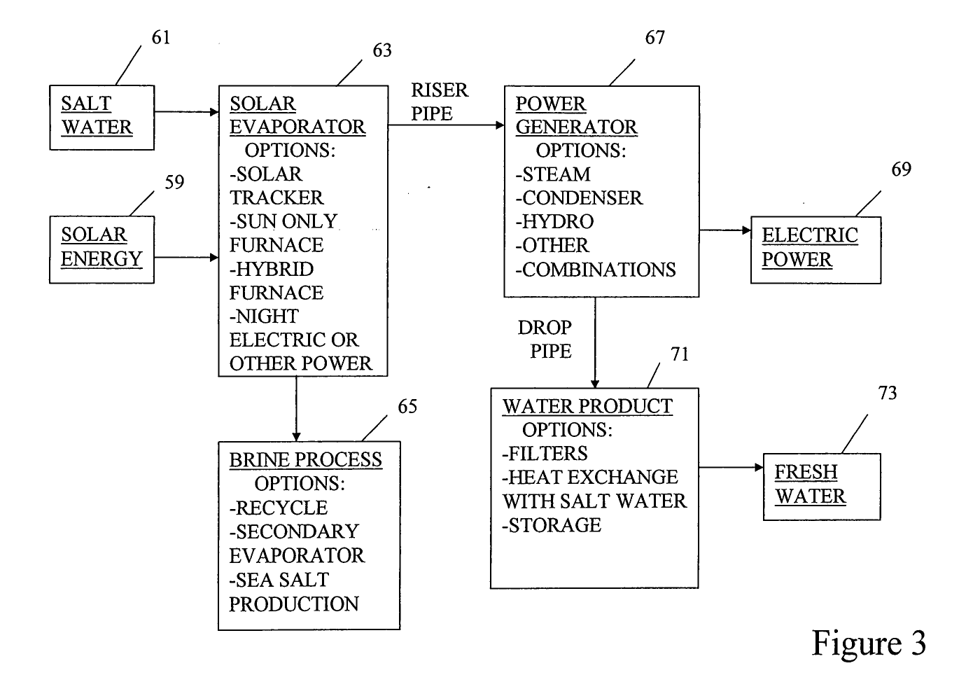

FIG. 3 illustrates a block diagram showing various options for some preferred embodiments of the present invention desalinated water-producing, electric power-generating solar desalination systems. The four larger blocks of FIG. 3 represent the four process steps of the present invention system and the four smaller blocks represent inputs and outputs. However, additional outputs are optionally viable, such as salt production and/or saline solution production. In FIG. 3, inputs include solar energy 59 and salt water 61 to solar evaporator 63. Solar evaporator 63 could be a solar furnace or a hybrid furnace. It could also have alternate energy powering for night or other use. Solar evaporator 63 preferably is rotatable and has sufficient tracking capabilities. For example, the vessel may remain stationary while the solar furnace rotates or both may rotate. Alternatively, remotely located reflectors may track the sun and solar furnace may be stationary. The brine treatment process 65 may involve a number of options including recycle, secondary evaporation and sea salt production.

The desalinated evaporant rises to a predetermined height through a column or riser pipe and the elevated water is utilized to generate electric power 69 at power generator 67. Power generator 67 options include steam, condenser, hydro, other and combinations thereof. Water product 71 illustrates various options that result in fresh water 73 and other inherent benefits.

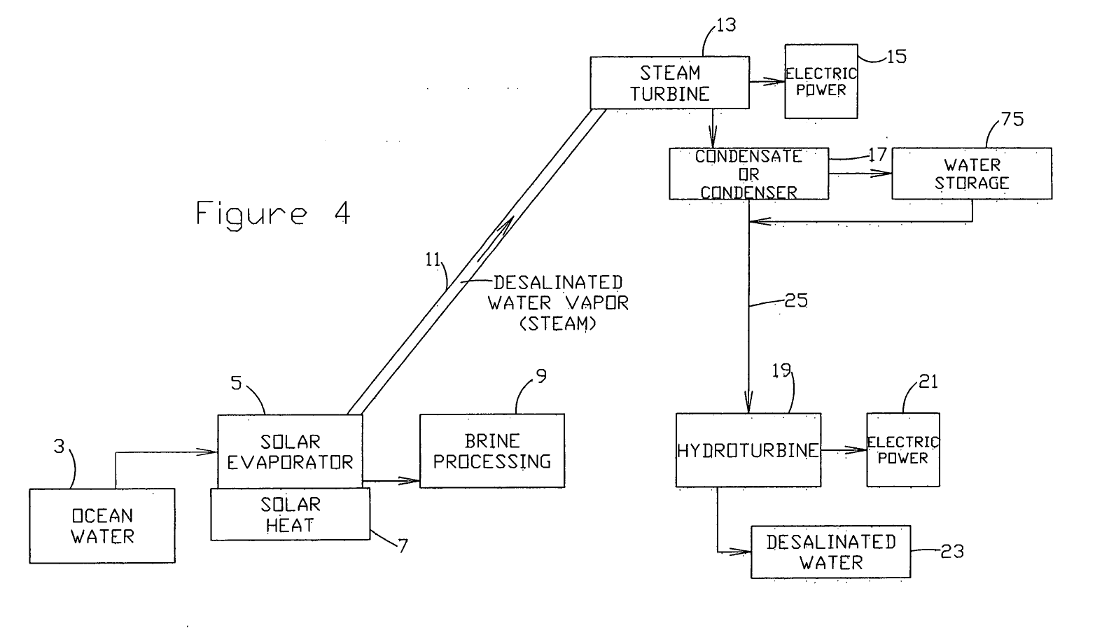

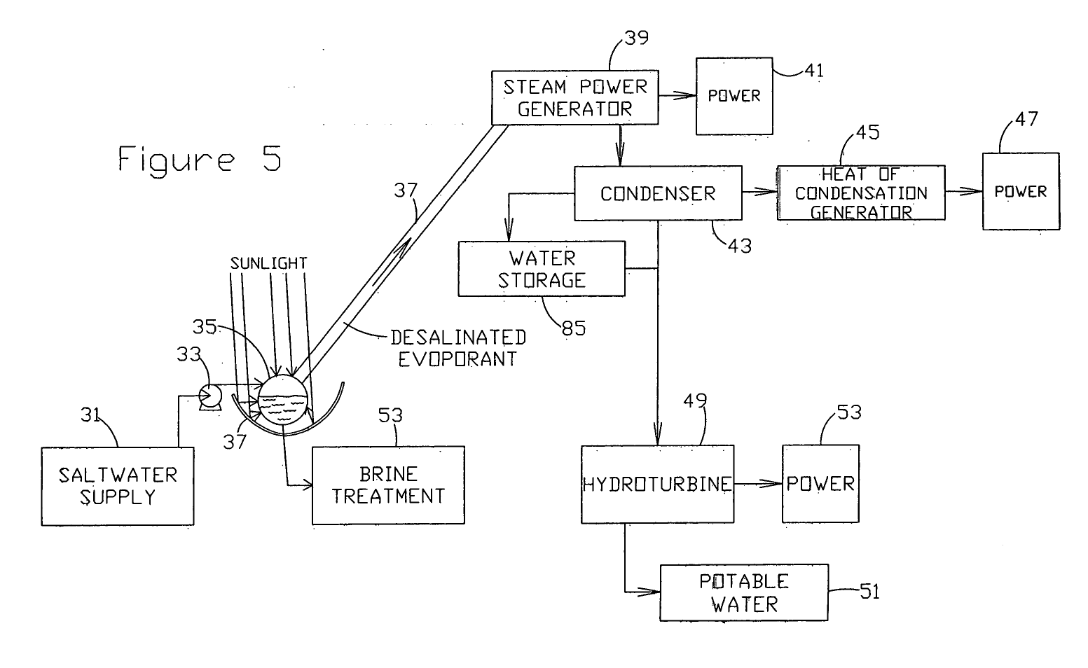

FIG. 4 is similar to FIG. 1 and identical components are identically numbered. However, in the FIG. 4 embodiments, condensate or condenser 17 water may be fed to drop pipe 25 directly or diverted to elevated Water storage 75. By storing water at an elevated level, it may be released at a slow, steady continuous or nearly continuous rate to generate electricity or it may be stored and used on days with low or no sun power. Similarly, FIG. 5 shows the same present invention systems shown in FIG. 2, but includes elevated water storage 85 for the same purposes and benefits described above.

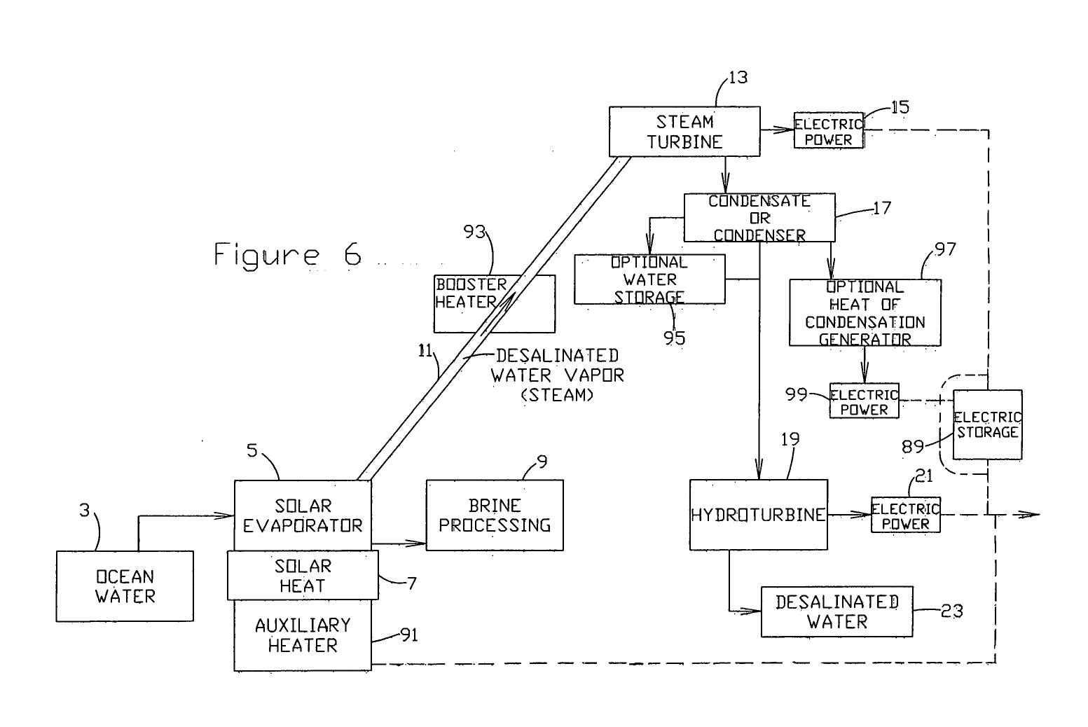

FIG. 6 illustrates variations of the FIG. 1 present invention desalinated water-producing, electric power-generating solar desalination systems, illustrating additional options. Otherwise, the elements shown in FIG. 6 that are identical to those in FIG. 1, are identically numbered. These options include a booster heater 93. The booster heater 93 could be any type of heating system, including electrical, but a solar booster would be most efficient. Also included is optional water storage 95 that may be utilized in a manner similar to water storage 75 described in conjunction with FIG. 4 above. Optional heat of condensation generator 97 produces additional electric power 99. Auxiliary heater 91 may be utilized to supplement and/or replace solar heat, depending upon sun availability, and the electric power used for auxiliary heater 91 may advantageously be taken from a grid or from the electric power generated and stored, as from electric storage 89.

FIG. 7 describes a continuous present invention solar desalination system. Block 101 illustrates that while the system is continuous, the salt water flow to the solar furnace (vessel and concentrator or collector) is variable. The quantity and rate of heat delivered to the vessel from the sun depend upon the time of day, day of year, cloudiness, wind and temperature of the incoming salt water. Thus, while the process can be continuous, the inflow of salt water must be variable to compensate for the aforesaid variables.

For example, present invention computer controlled system has a six ton volume a vessel in the form of a long tube positioned on the focal line of a linear parabolic reflector could have a top inlet for ocean water at one end and a bottom outlet for brine bottoms at the opposite end. The inlet could be fed by a variable rate pumping system (or gravity flow system where the solar furnace is located below the sea water) and the bottoms outlet could have a variable rate valving system a monitor could measure a process parameter such as vessel water level, vessel water weight or steam output and would regulate the inlet flow in accordance with defined process parameter limitations. Likewise, the bottoms outflow could be regulated by the inflow rate such as ten percent of inflow. It is desired to maintain a water level between four and five tons of salt water. The computer control program is designed to maintain the bottoms outlet valve closed during the initial fill stage. The solar furnace will begin to evaporate desalinated water to a riser pipe for steam power generation and hydroelectric power generation (block 103). When the vessel water level or weight drops to, for example, five tons, the inlet pumping system will automatically pump salt water to the vessel. The computer system will recognize the inlet flow rate or steam output to open and regulate the flow rate of the brine bottoms (block 105). For example, if the water evaporates and a rate of one ton per hour then the next inlet pumping system will feed replacement salt water at the rate of one ton per hour, then and the brine bottoms outlet will permit 0.1 ton of brine to be released per hour. Such a system would generate 0.9 ton of steam per hour to generate electricity. The desalinated water could be stored at elevation and used to generate electricity though a hydroturbine at night or during low sunlight to electrically power the solar furnace for additional operational time (block 107). The desalination water products may be subject to further water treatment filtering, UV, etc. (block 109). The brine may be treated and brine treatment may include ponding recycling, sea salt production, etc. and combinations (block 111). When effective evaporation has ceased, the computer controlled system recognizes the lack of evaporant removal, and shuts down the system.

FIG. 8 illustrates the present invention process as a batch process. The salt water is periodically delivered to the solar furnace vessel (block 121) to a predetermined fill level and the feed is shut down. The solar furnace will evaporate the contents of the vessel until a predetermined weight or volume or fill level has been evaporated, and then a computer controlled monitoring system will open a bottoms release valve and initiate flushing with salt water (block 125). After the flushing is completed and the vessel is drained of bottoms, the computer will close the bottoms release valve, and may again initiate a fill step and repeat the process as above.

As with the continuous system, the desalination evaporant (steam) travels up a riser pipe for steam generation and hydro generation of electric power (block 123). The desalinated water may be fed to a hydroelectric generator or completely or partially stored. The stored water could be used to create power for the solar furnace when there is no or low sunlight (block 127). The desalination water products may be subject to further water treatment, such as filtering, UV, etc. (block 129). The brine may be treated and brine treatment may include ponding recycling, sea salt production, etc. and combinations (block 111).

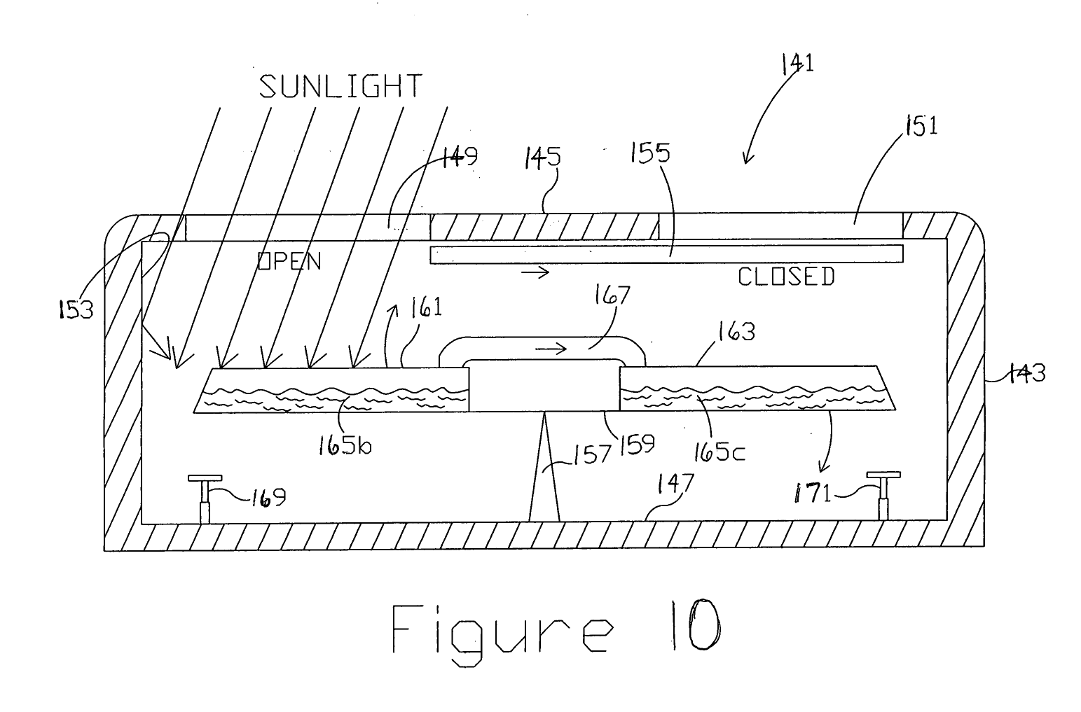

FIGS. 9 through 28 show various embodiments of a reciprocating solar engine used to power the pump that supplies seawater or other salt water to the vessel. The reciprocating solar engine is based on material transfer back and forth across a fulcrum utilizing solar energy to cause the material transfer. The material transfer occurs when solar energy heats a liquid in a container to cause some vaporization of the liquid, the vaporized liquid (gas) then condenses to liquid in a container on the opposite side of the fulcrum, and the weight shift causes mass to rotate about the fulcrum. The present invention reciprocating solar engine may be used as a driving force for any purpose, e.g. turning a turbine to generate electricity, operating a pump to move liquid such as water, operating reciprocating pistons, or turning a production wheel.

FIG. 9 is a side cut view of a preferred embodiment of a present invention reciprocating solar engine 141. Solar engine 141 includes a main housing 143 with a bottom 147 and side walls such as wall 153. Housing 143 also has a roof 145, with a first (left) window 149 and a second (right) window 151. The size and position of the windows are considered in conjunction with the solar heat-receiving closed containers. There is an elongated sun blocking shutter means, in this case single door 155. Door 155 is on sliders or tracks (not shown) and has a first rest position where window 149 is open and window 151 is closed, and a second rest position where window 149 is closed and window 151 is open. Within housing 143 is a central fulcrum support 157 and a platform 159 located atop central fulcrum support 157 so that platform 159 is rotatable on the central fulcrum support 157 about its axis of rotation shown as x in FIG. 9.

Positioned evenly on platform 159 are two solar heat-receiving closed containers. To the left of the central fulcrum support 157, on platform 159, is solar heat-receiving closed container 161 and to the tight of the central fulcrum support 157, on platform 159, is solar heat-receiving closed container 163. There is a connecting means, in this case tube 167, that connects the two solar heat-receiving closed containers. They, along with platform 159, move up and down through a predetermined arc. The predetermined arc is defined by any one or more of a number of variables that may be included or are inherent in any given device. Thus, the predetermined arc is limited by the space in the housing 143 or, more specifically, the roof 145 of the housing 143, the height of the central fulcrum support 157 and the length of the platform 159. Beyond that, brakes, stops, gears, shutter controls or other features may represent a bottom or top of the predetermined arc.

Contained within at least one of the two solar heat-receiving closed containers is a fluid that is capable of being at least partially vaporized to gas by solar heat and will otherwise rest in equilibrium in the container(s), possibly with some of the fluid in the gaseous state before solar heat is applied. The connecting tube is open from the left to the right containers and vice versa for transport of the vaporized fluid from the warmer container (solar heated) to the cooler container, due to gases expanding and rising. Once in the cooler container (solar shaded), the gases will at least partially condense, shifting the fluid and hence the weight of the fluid from the warmer to the cooler container. When the shutter means closes a first window and opens a second window, it shuts off most of the solar heat at the first window and allows solar heat to enter through the second window.

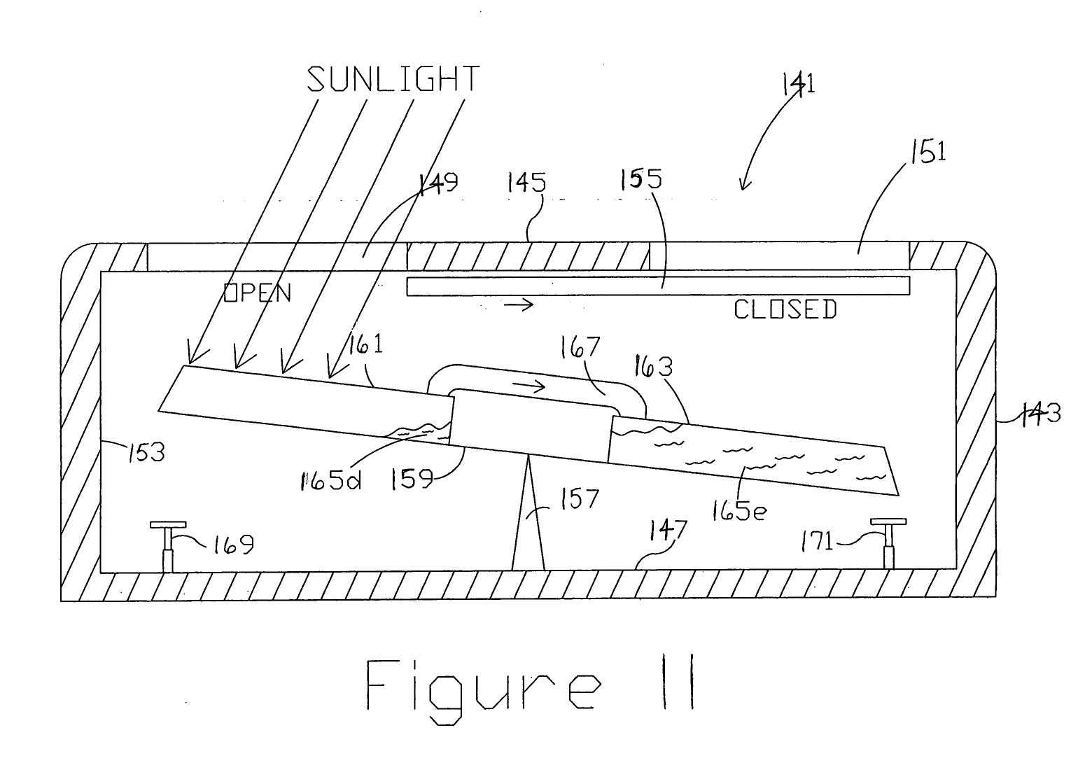

Referring again more specifically to FIG. 9, window 149 is open and window 151 is closed by virtue of the positioning of door 155, as shown in the Figure. Sunlight enters window 149 and not window 151. As sunlight enters window 149, it heats up container 161 and fluid 165a starts to boil over through tube 167 to container 163 where it at least partially condenses. Eventually, the weight shift will cause the right side of platform 159 to go down and the left side to go up. This is rotation of the platform about its axis of rotation x. The process is followed in more detail in FIGS. 10 through 14, where identical elements are identically numbered.

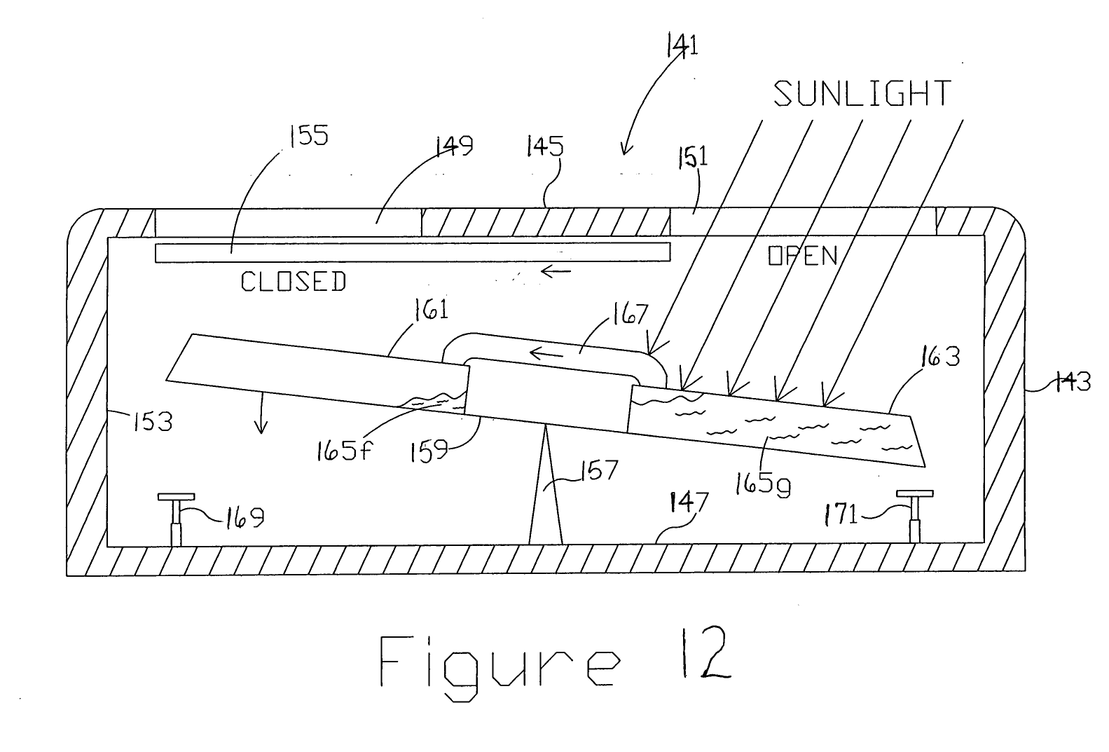

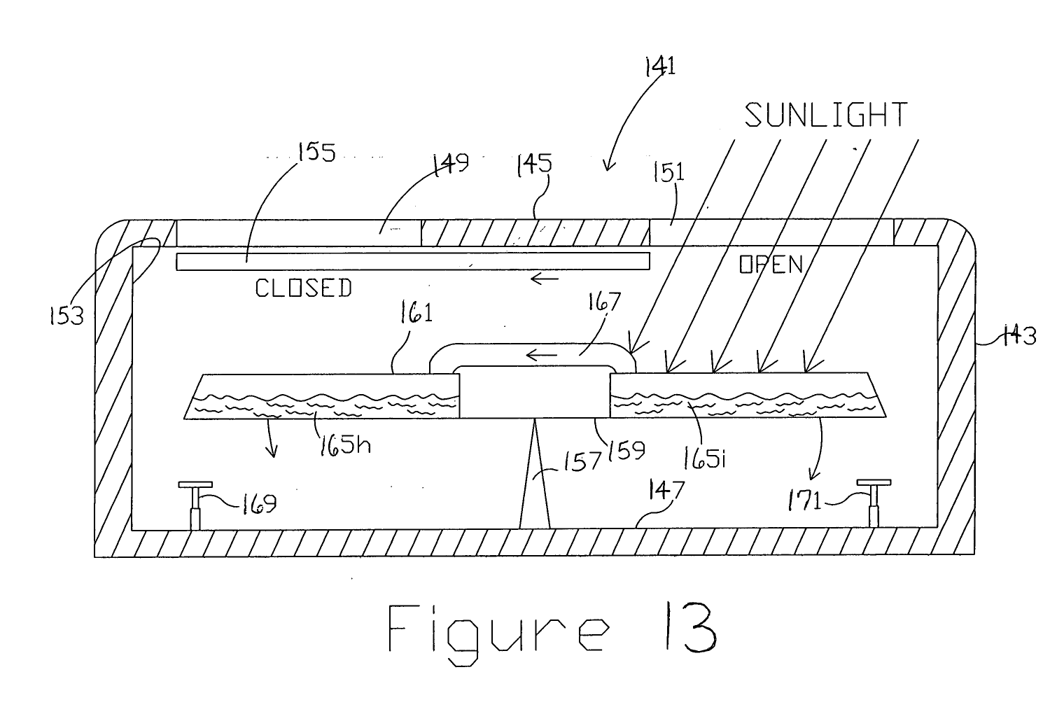

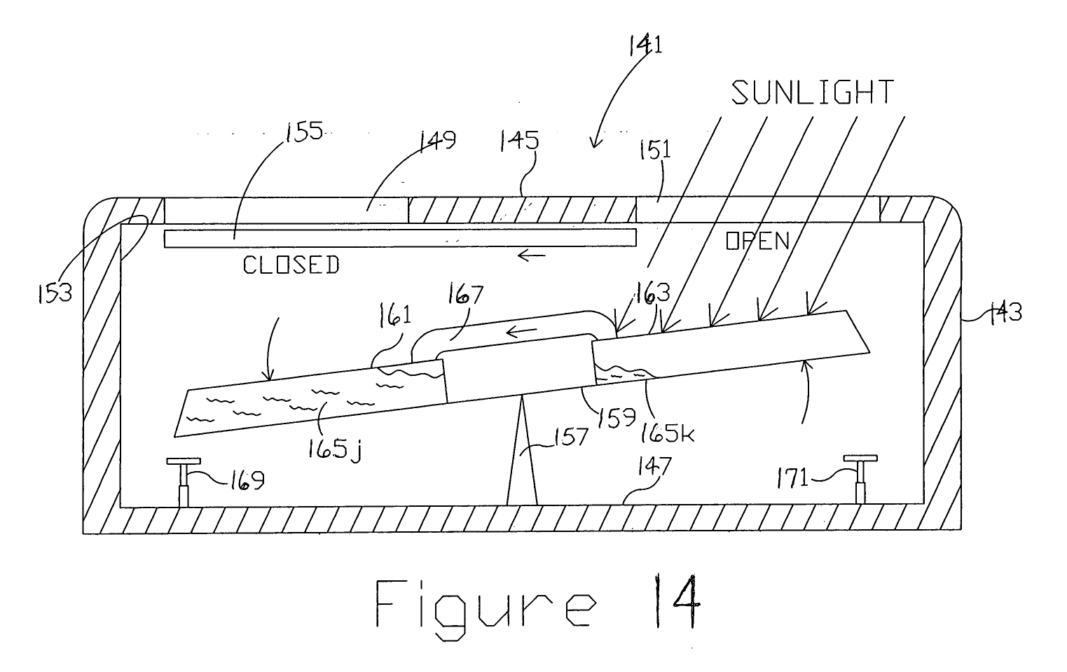

Thus, FIGS. 10 through 14 show side cut views of the preferred embodiment present invention reciprocating solar engine 141 shown in FIG. 9, but in different positions of a reciprocal cycle. In FIG. 10, sunlight through window 149 continues to evaporate the fluid of container 161 over to the cooler container 163, with the rotation as shown, so that when container 161 and container 163 have equal weights of fluid 165b and 165c therein, they are approximately in balance. The platform 159 and the containers continue to rotate as more liquid is boiled over, and this is shown in FIG. 11, where now there is little fluid 165d in container 161 and most of the liquid has boiled over to container 163 (fluid 165e), as shown. The process continues until the right side of platform 159 hits shutter control means lever 171. When this occurs, the shutter control means is activated and door 155 is moved to the right to its second rest position as shown in FIG. 12. Here the process immediately reverses itself and the sunlight is closed from window 165 and now enters window 151 where it heats up container 163. The fluid 165g heats and partially boils over through tube 167 back into container 161, as condensed fluid 165f. In FIG. 13, the process continues as more solar energy (sunlight) heats container 163 and its contents, fluid 165i, wherein fluids 165h and 165i are about equal. In FIG. 14, most of the fluid 165j has boiled over to shuttered (shaded) container 161, with little fluid 165k remaining in container 163. Next, the excess weight of the left side would cause platform 159 to contact shutter control means lever 169, which causes door 155 to move right, opening window 149 and closing window 151 again as in FIG. 9. Then this reciprocating process described merely repeats itself. The actual mechanism of the levers 169 and 171 triggering door or shutter means movement is not critical to the process, as any know means will work. Such mechanisms include, but as not limited to pulleys, hydraulics, pneumatics, gears, linkages, power driven (motorized) with wires or wireless activation.

The fluids utilized may be any organic or inorganic fluids, including water. However, organic fluids, and especially low boiling point fluids, such as low carbon chain organic fluids and low boiling point alcohols, are preferred. Any fluids discussed in the present inventor's issued U.S. Pat. No. 4,079,249, incorporated herein by reference, may be used, as well as any within the skill of the artisan, such as are used in published liquid-based solar tracking devices. U.S. Pat. No. 4,079,249, issued to Kenneth P. Glynn on Mar. 14, 1978 and entitled “Solar Energy Operated Motor Apparatus” is incorporated herein in its entirety.

The solar heat-receiving closed containers used herein are open to the connecting means to the opposite containers, but are otherwise closed to the atmosphere to prevent evaporative losses of the fluids therein. In some instances, depending upon the volatility of the fluid and the environment, it may be useful to provide and expansion chamber for the boiling gases, such as in the connecting tube. However, usually this will not be necessary, as actual reciprocating devices were built and functioned without the need for gas expansion accommodation. The containers may be made of one or a combination of materials and may be transparent, translucent or opaque. For example, metal containers may absorb solar heat well and transfer the heat to the fluids without any transparency whatsoever. Clear or translucent materials such as plastics or glass, may alternatively be used and these will allow sunlight to directly heat the fluids. Mirrors or other reflectors may be used inside or outside the roof or housing to increase the light hitting the containers. In some embodiments, transparent or translucent containers may have black bases to enhance heat absorption. Magnifying glasses may be strategically positioned to increase the amount of solar heat contacting the containers.

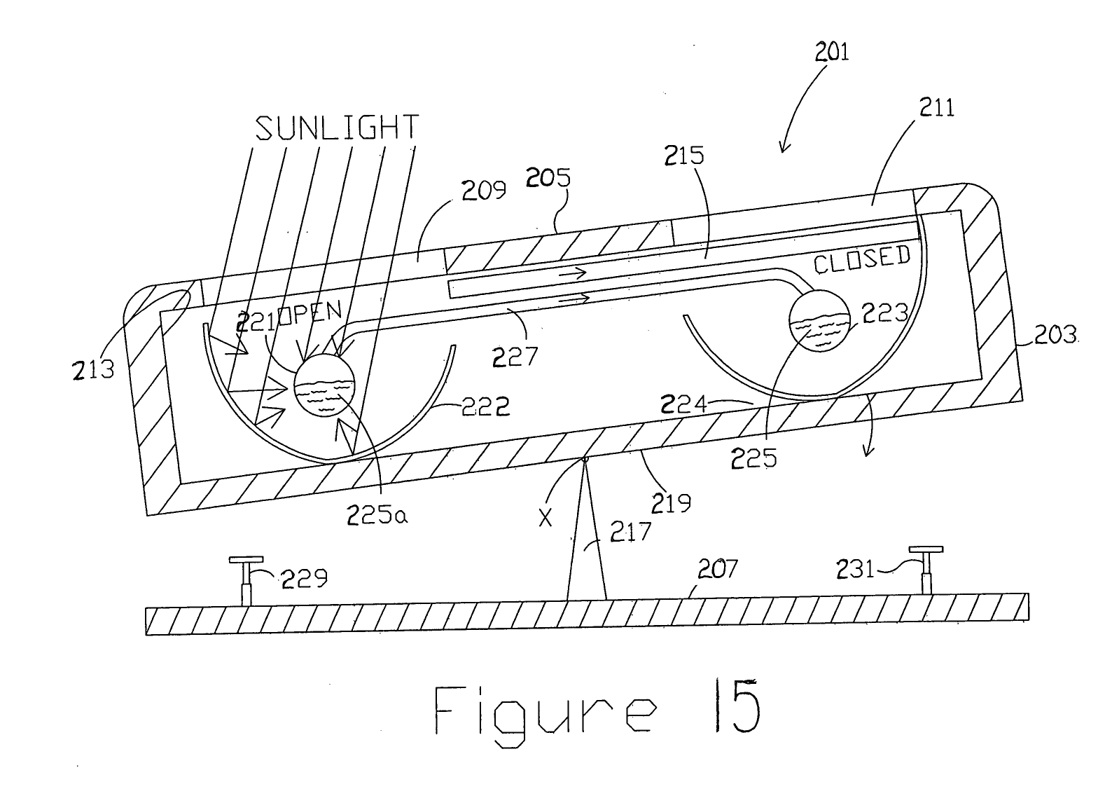

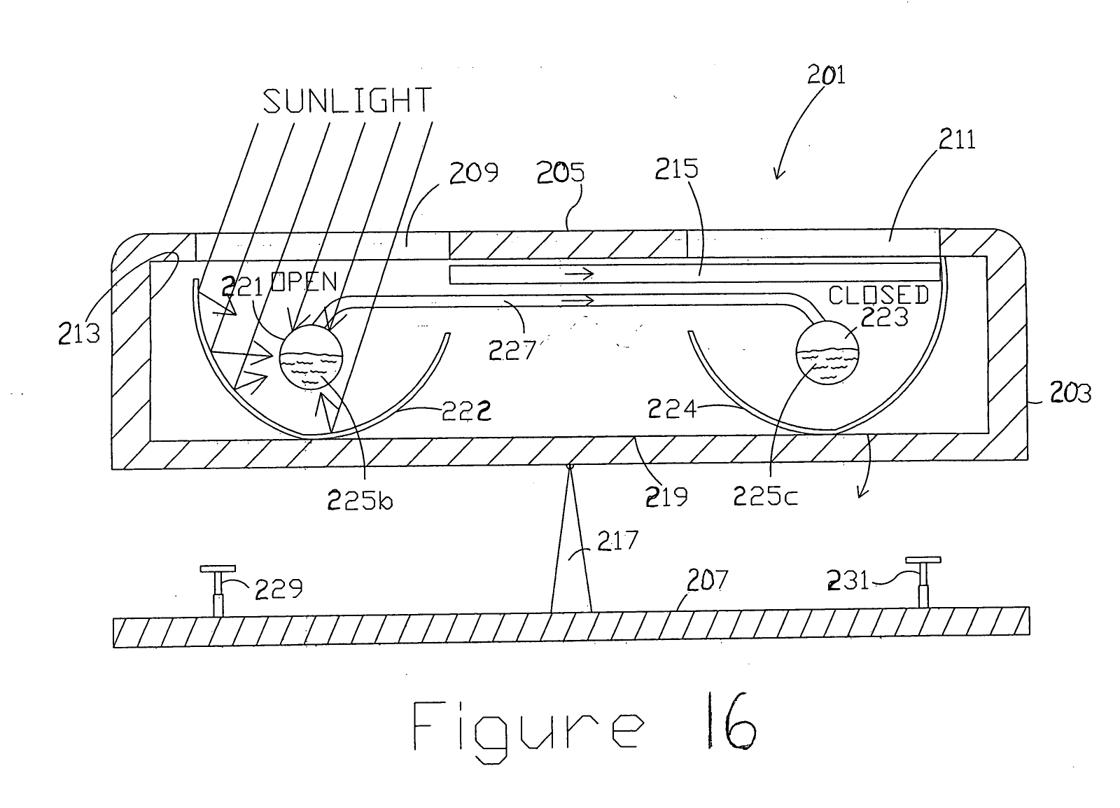

FIG. 15 is a side cut view of a preferred embodiment of a present invention reciprocating solar engine 201. Solar engine 201 includes a base 207, with a central fulcrum support 217 thereon. The support 217 is represented as a triangular support, but could be any form of fulcrum support means. A platform 219 is located atop central fulcrum support 217 so that platform 219 is rotatable on the central fulcrum support 217 about its axis of rotation shown as x in FIG. 9. There is a main housing 203 with side walls such as wall 213. Housing 203 also has a roof 205, with a first (left) window 209 and a second (right) window 211. The size and position of the windows are considered in conjunction with the solar heat-receiving closed containers and the reflectors. There is an elongated sun blocking shutter means, in this case single door 215. Door 215 is on sliders or tracks (not shown) and has a first rest position where window 209 is open and window 211 is closed, and a second rest position where window 209 is closed and window 211 is open. Housing 203 is directly or indirectly attached to platform 219 so as to move with it.

Positioned evenly on platform 219 are two solar heat-receiving closed containers. To the left of the central fulcrum support 217, on platform 219, is solar heat-receiving closed container 221 and to the right of the central fulcrum support 217, on platform 219, is solar heat-receiving closed container 223. These containers 221 and 223 may be spherical, cylindrical, rectilinear or otherwise shaped. Reflectors 222 and 224 are positioned adjacent containers 221 and 223, respectively so as to concentrate sunlight from the reflectors onto the containers. These reflectors may be angled flats, curved, combinations of curved or flat, parabolic (linear parabolas), parabolaloids (rotated parabolas, especially for spherical containers), or any combinations of these. Most importantly, the reflectors are designed, shaped and positioned to be provided additional solar heat to the containers. This may enable the system to function with more liquids, to operate faster or more efficiently, to utilize lower boiling point liquids, to generate more energy out of the device for a given time period, or any combinations of these. Preferred would be linear parabolas with horizontal linear cylinders positioned at the focal line of the linear parabolas. The reflector further may be polished or other reflective metal, plastic or glass mirrors or combinations thereof.

There is a connecting means, in this case tube 227, that connects the two solar heat-receiving closed containers 221 and 223. They, along with platform 219, move up and down through a predetermined arc. The predetermined arc is defined by any one or more of a number of variables that may be included or are inherent in any given device. Thus, the predetermined arc is limited sometimes by the space considerations or, more specifically, by a shed or house, such as a glass roof house or greenhouse (not shown) within which the solar engine 201 may be maintained, by the height of the central fulcrum support 217 and by the length of the platform 219. Beyond that, brakes, stops, gears, shutter controls or other features may represent a bottom or top of the predetermined arc.

Contained within at least one of the two solar heat-receiving closed containers is a fluid that is capable of being at least partially vaporized to gas by solar heat and will otherwise rest in equilibrium in the container(s), possibly with some of the fluid in the gaseous state before solar heat is applied. The connecting tube is open from the left to the right containers and vice versa for transport of the vaporized fluid from the warmer container (solar heated) to the cooler container, due to gases expanding and rising. Once in the cooler container (solar shaded), the gases will at least partially condense, shifting the fluid and hence the weight of the fluid from the warmer to the cooler container. When the shutter means closes a first window and opens a second window, it shuts off most of the solar heat at the first window and allows solar heat to enter through the second window.

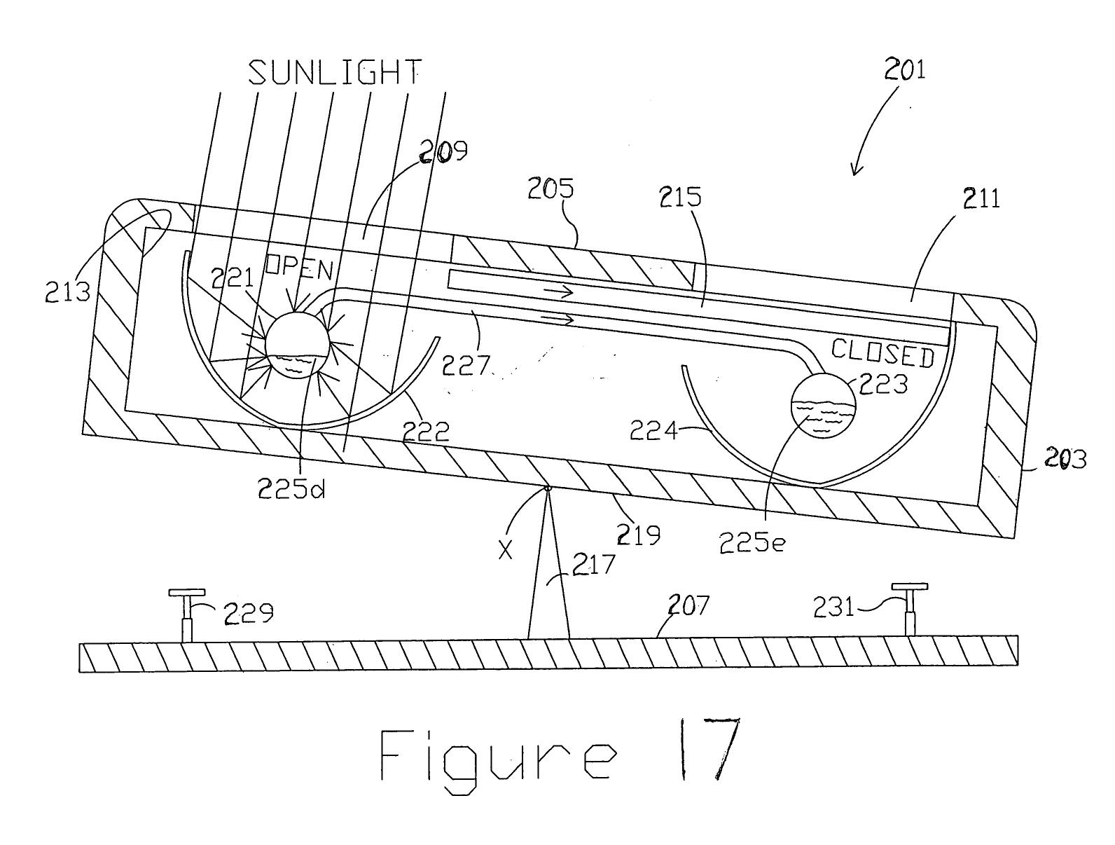

Referring again more specifically to FIG. 15, window 209 is open and window 211 is closed by virtue of the positioning of door 215, as shown in the Figure. Sunlight enters window 209 and not window 211. As sunlight enters window 209, it is concentrated toward container 221 by reflector 222, as shown, and heats up container 221. Fluid 225a starts to boil over through tube 227 to container 223 where it at least partially condenses. Eventually, the weight shift will cause the right side of platform 219 to go down and the left side to go up. This is rotation of the platform about its axis of rotation x. The process is followed in more detail in FIGS. 16 through 20, where identical elements are identically numbered.

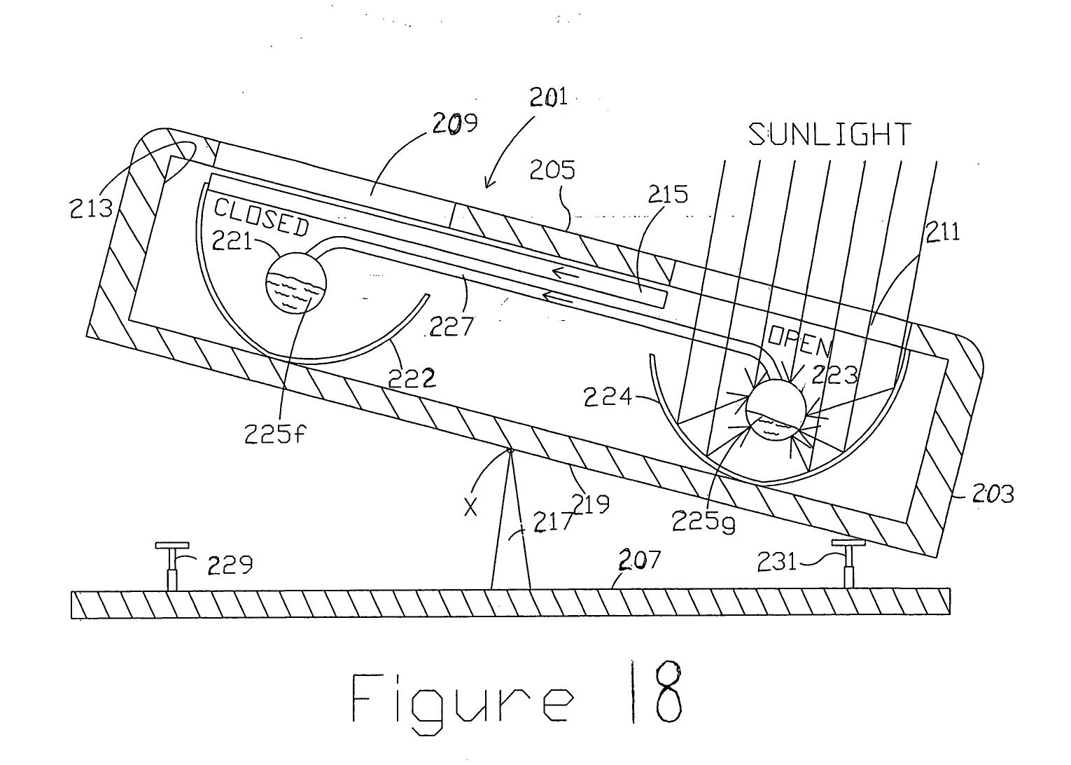

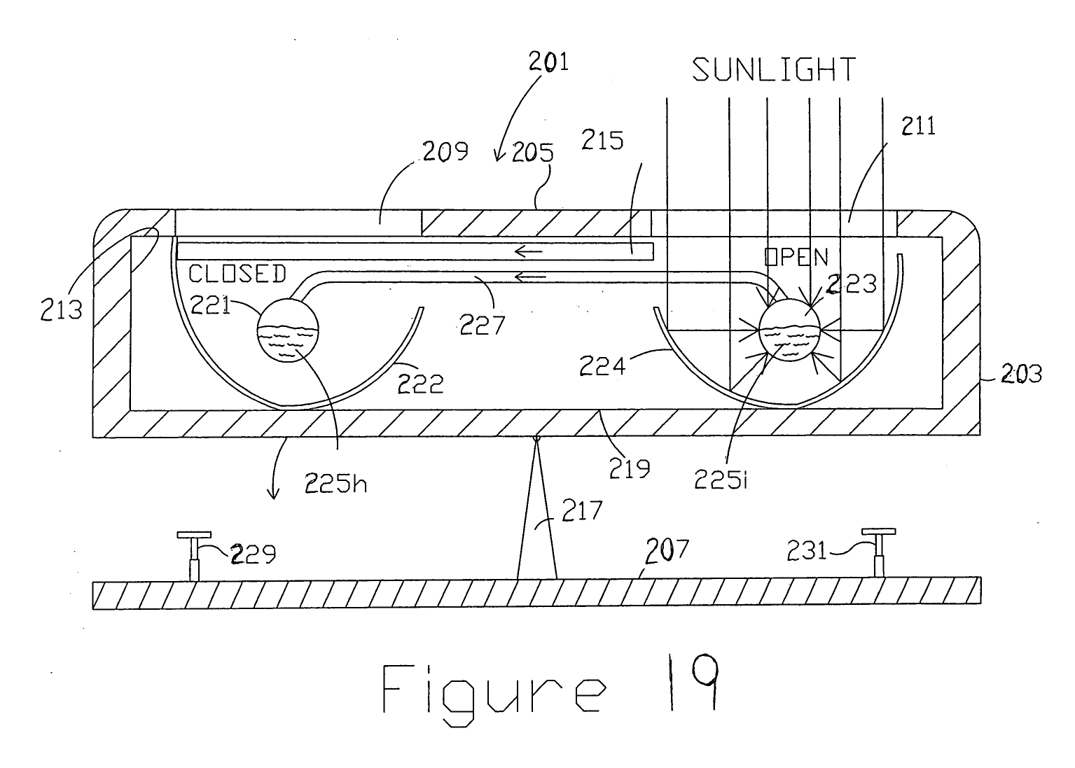

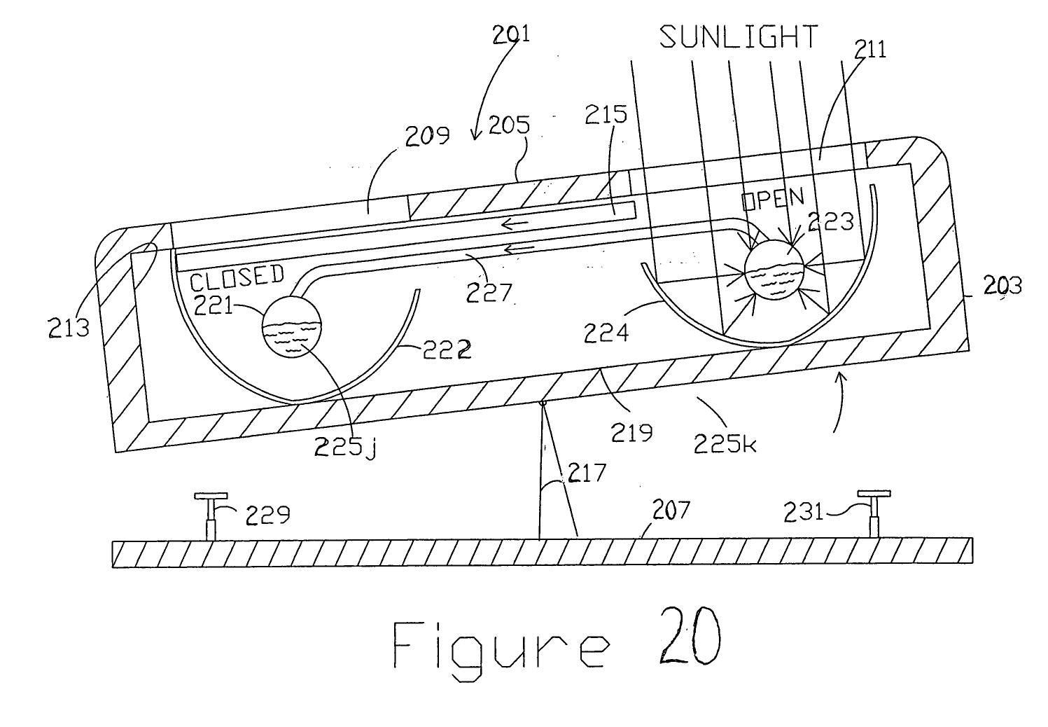

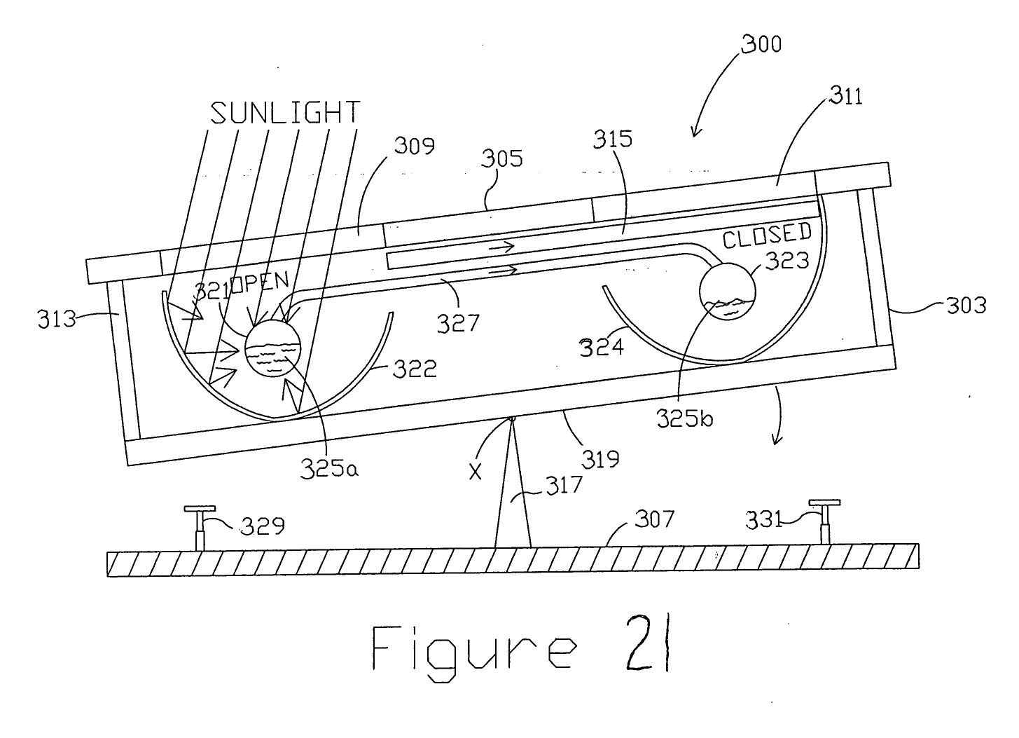

Thus, FIGS. 16 through 20 show side cut views of the preferred embodiment present invention reciprocating solar engine 201 shown in FIG. 15, but in different positions of a reciprocal cycle. In FIG. 16, sunlight through window 209 continues to evaporate the fluid of container 221 over to the cooler container 223, with immediate or eventual the rotation as shown, so that when container 221 and container 223 have equal weights of fluid 225 b and 225c therein, they are approximately in balance. The platform 219 and the containers continue to rotate as more liquid is boiled over, and this is shown in FIG. 17, where now there is little fluid 225d in container 221 and most of the liquid has boiled over to container 223 (fluid 225e), as shown. The process continues until the right side of platform 219 hits shutter control means lever 231. When this occurs, the shutter control means is activated and door 215 is moved to the right to its second rest position as shown in FIG. 18. Here the process immediately reverses itself and the sunlight is closed from window 225 and now enters window 211 where it heats up container 223. The fluid 225g heats and partially boils over through tube 227 back into container 221, as condensed fluid 225f. In FIG. 19, the process continues as more solar energy (sunlight) heats container 223 and its contents, fluid 225i, wherein fluids 225h and 225i are about equal. In FIG. 20, most of the fluid 225j has boiled over to shuttered (shaded) container 221, with little fluid 225k remaining in container 223. Next, the excess weight of the left side would cause platform 219 to contact shutter control means lever 229, which causes door 215 to move right, opening window 209 and closing window 211 again as in FIG. 15. Then this reciprocating process described merely repeats itself. The actual mechanism of the levers 229 and 231 triggering door or shutter means movement is not critical to the process, as any known means will work. Such mechanisms include, but as not limited to pulleys, hydraulics, pneumatics, gears, linkages, power driven (motorized) with wires or wireless activation.

The fluids utilized may be any organic or inorganic fluids, including water. However, organic fluids, and especially low boiling point fluids, such as low carbon chain organic fluids and low boiling point alcohols, are preferred. Any fluids discussed in the present inventor's issued U.S. Pat. No. 4,079,249, incorporated herein by reference, may be used, as well as any within the skill of the artisan, such as are used in published liquid-based solar tracking devices. U.S. Pat. No. 4,079,249, issued to Kenneth P. Glynn on Mar. 14, 1978 and entitled “Solar Energy Operated Motor Apparatus” is incorporated herein in its entirety.

The solar heat-receiving closed containers used herein are open to the connecting means to the opposite containers, but are otherwise closed to the atmosphere to prevent evaporative losses of the fluids therein. In some instances, depending upon the volatility of the fluid and the environment, it may be, useful to provide and expansion chamber for the boiling gases, such as in the connecting tube. However, usually this will not be necessary, as actual reciprocating devices were built and functioned without the need for gas expansion accommodation. The containers may be made of one or a combination of materials and may be transparent, translucent or opaque. For example, metal containers may absorb solar heat well and transfer the heat to the fluids without any transparency whatsoever. Clear or translucent materials such as plastics or glass, may alternatively be used and these will allow sunlight to directly heat the fluids. Mirrors or other reflectors may be used inside or outside the roof or housing to increase the light hitting the containers. In some embodiments, transparent or translucent containers may have black bases to enhance heat absorption. Magnifying glasses may be strategically positioned to increase the amount of solar heat contacting the containers.

FIG. 21 is a side cut view of another preferred embodiment of a present invention reciprocating solar engine 300 with a roof 305 with open supports, such as support posts 303 and 313, attached to platform 319, in place of closed walls. This enables air to freely flow about the containers. In some environments this is preferred to air cool the shaded containers, while in other environments, such as in extreme wind, the closed housing is preferred to reduce heat losses at the heated container. Yet another alternative is a housing with ventilating openings, or vents that can be opened or closed, as needed. In FIG. 21 are windows 309 and 311 in roof 305, with a central large window shuttering door 315. There is a base 307 with a central fulcrum support 317 and the aforementioned platform 319 rotatably mounted on or connected to central fulcrum support 317. Platform 319 has two opposing solar heat-receiving closed containers 321 and 323, solar heat concentrator reflectors 322 and 324 positioned strategically as shown for each of the two containers 321 and 323, respectively. Containers 321 and 323 are connected by connecting tube 327. As shown, there is significant fluid 325 in container 321. There are also two shutter control levers 329 and 331. This engine 300 operates the same as the one shown in FIGS. 15 through 20 above.

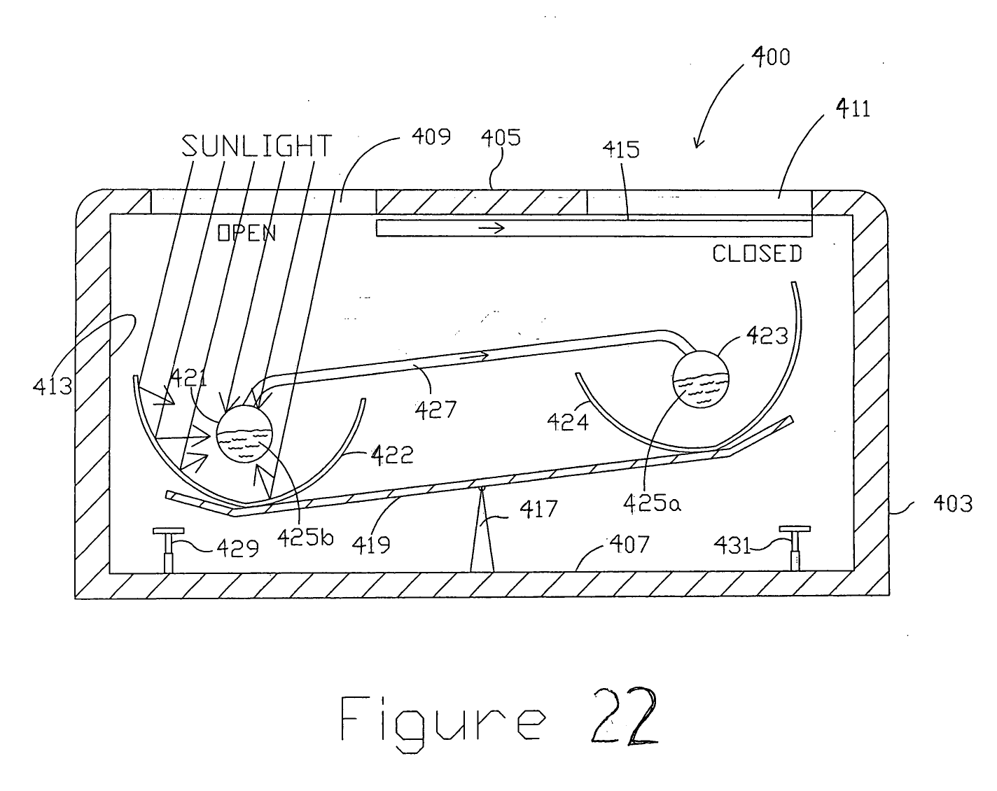

FIG. 22 is a side cut view of another preferred embodiment of a present invention reciprocating solar engine 400 with a magnifying lenses 409 and 411 in each of the respective windows of roof 405, to function as solar, energy concentrators. Housing 403 has a roof 405, side walls, such as side wall 413 and surrounds platform 419. Roof 405 has a central large window shuttering door 415, that keeps one window open and the other closed and versa. In FIG. 22, present invention reciprocating solar engine 400 also includes a base 407, a central fulcrum support 417 to rotatably support platform 419. Platform 419 has two opposing solar heat-receiving closed containers 421 and 423, connected by connecting tube 427. Reflector 422 surrounds containers 421 and reflector 424 surrounds container 423 to concentrate heat, as shown. There is significant fluid 425a in container 423 and a small amount of fluid 425b in container 421. There are also two shutter control levers 429 and 431. The lenses will provide more concentrated solar energy, as shown in the Figure, and, in some embodiments, allow for higher boiling point fluids in the container than might be uses without the concentrator lenses. Except for the concentration of solar heat caused by the lenses 409 and 411, to either provide higher temperatures, faster boiling or both, this engine 400 operates the same as the one shown in FIGS. 15 through 20 above.

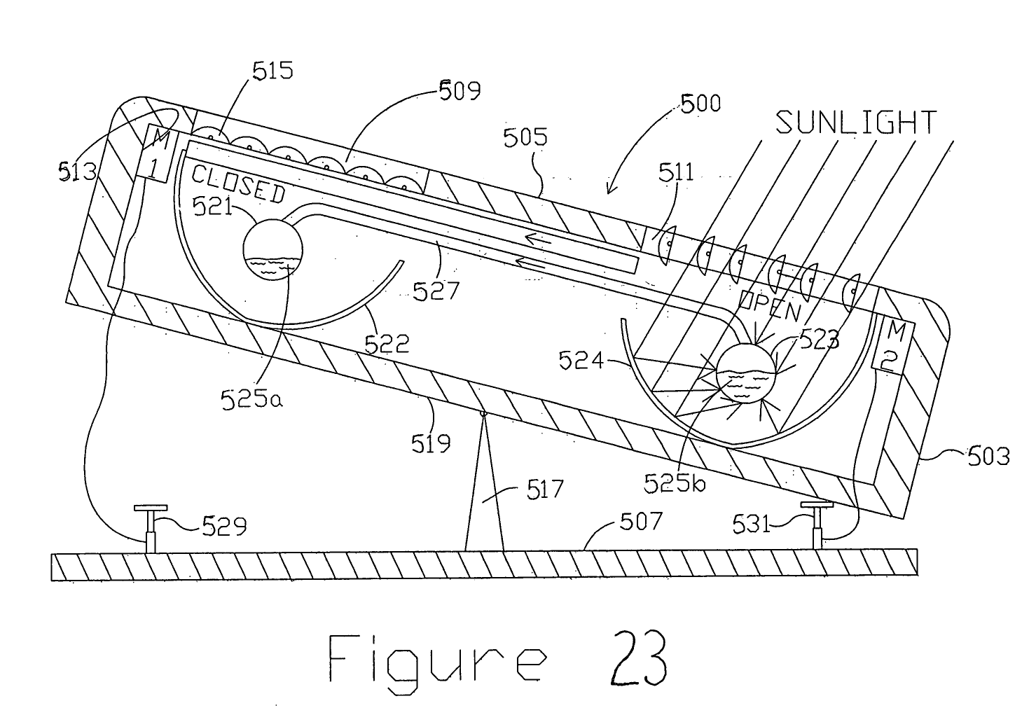

FIG. 23 is a side cut view of another preferred embodiment of a present invention reciprocating solar engine 500 with sets of shutters or blinds 515 and 535, respectively, for windows 509 and 511 of roof 505, to function as the window shutter means. One set is open when the other is closed and vice versa. They respond to the contact of the reciprocating platform 519 to shutter control means levers 529 and 531 via wires and responsive electric drive motors M₁ and M₂. (The details of motor driven blinds or shutters are not shown, as such are commercially available and well known, although not in the context of the present invention reciprocating solar, engine windows. However, the same motors and drives, linkages and gears used in conventional motor driven blinds could be used here.) In place of the motorized operation, the blinds could be operated by hydraulic connections, pneumatic connections, mechanical linkages, pulleys, pulleys and weights, counterweights, gears or any combination thereof, or any other drive means to cause responsive movement to the actuation of one lever 529 or the other lever 531. In FIG. 23, present invention reciprocating solar engine 500 includes housing 503, with roof 505 side walls such as side wall 513. There is also a base 507, a central fulcrum support 517 and a platform 519. Platform 519 has two opposing solar heat-receiving closed containers 521 and 523, connected by connecting tube 527. Reflectors 522 and 524 are adjacent containers 521 and 523, respectively to concentrate solar heat on the containers. As shown, there is significant fluid 525b in container 523 and a small amount of fluid 525a in container 521. There are also two shutter control levers 529 and 531. Except for the different choice of shutter means and shutter means controls, this engine 500 operates the same as the one shown in FIGS. 15 through 20 above.

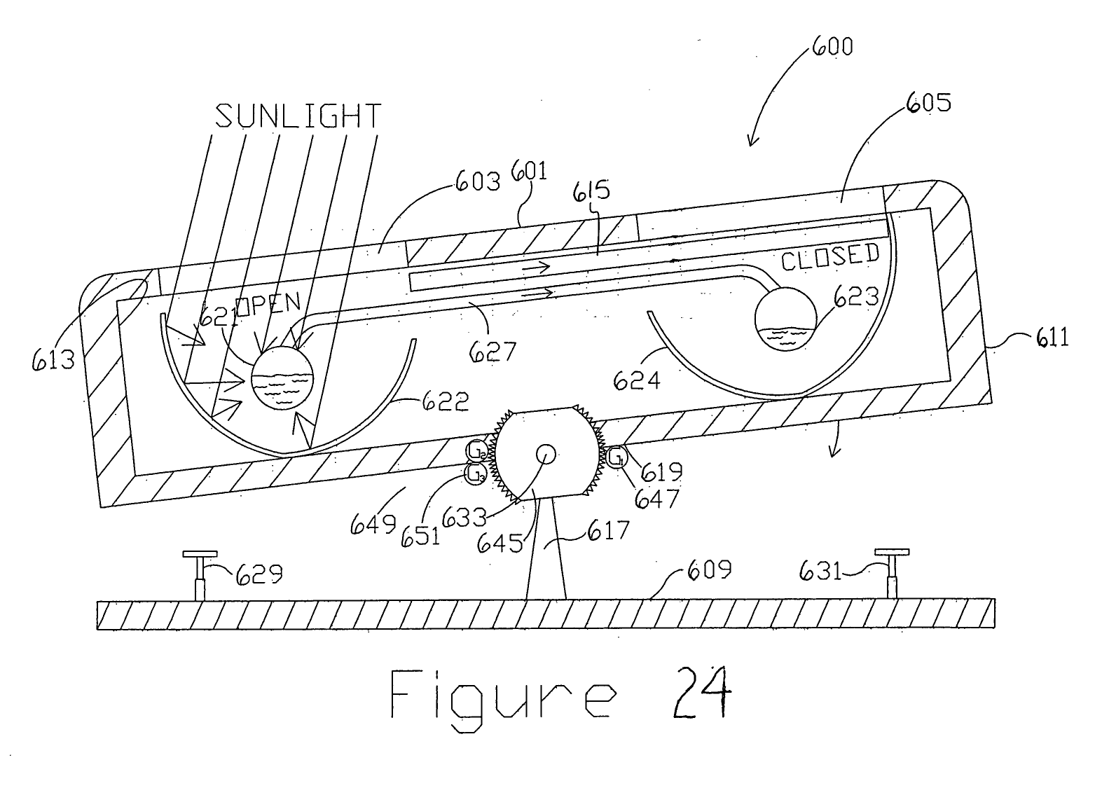

FIG. 24 is a side cut view of another preferred embodiment of a present invention reciprocating solar engine 600 with the device as shown in FIG. 15 but with a gear driving shaft take-off connected to the reciprocating platform 619 at its axis of rotation. Housing 611 has a roof 601, side walls, such as side wall 613, and is attached to the platform 619. Roof 601 has windows 603 and 605, and a central large window shuttering door 615, that keeps one window open and the other closed and versa. In FIG. 24, present invention reciprocating solar engine 600 also includes a base 609 that holds central fulcrum support 617 in place, and platform 619 is rotatably connected to or nested on or in support 617. Platform 619 has two opposing solar heat-receiving closed containers 621 and 623, with reflectors 622 and 624, connected by connecting tube 627. As shown, there is significant fluid in container 621 and a small amount of fluid in container 623. There are also two shutter control levers 629 and 631. This present invention engine 600 operates the same as the one shown in FIGS. 15 through 20 above. As the platform moves through its reciprocal motion as described in conjunction with FIGS. 15 through 20 above, main gear 645 rotates back and forth. When platform 619 is moving down on its right as shown by the arrow under container 623, main gear 645 rotates clockwise and it rotates gear 647 counterclockwise. Gear 647 has a take off drive to any desired operation, such as an electric generator. Gear 647 is a slip gear that will engage its takes off when gear 647 is moving counterclockwise and not when rotating clockwise, In essence, it only runs the generator in one direction (counterclockwise take off). Gear 649 works in the opposite fashion. When platform 619 is moving down on its left side, main gear 645 rotates counterclockwise and it rotates gear 649 clockwise. Gear 649 has a connecting gear 651 that rotates counterclockwise and is likewise connected to a take off drive to any desired operation, such as an electric generator. Gear 649 is a slip gear that will engage its connecting gear 651 when gear 649 is moving clockwise and not when rotating counterclockwise. In essence, it only runs the generator in one direction (counterclockwise take off from gear 651). Thus, in this embodiment, whether platform 619 is seesawing clockwise or counterclockwise, the generator will be driven and always in the same direction. Alternatively, a generator can be driven directly from the platform central axis of rotation and have a pole reversing mechanism so that no slip gear or other arrangement is necessary.

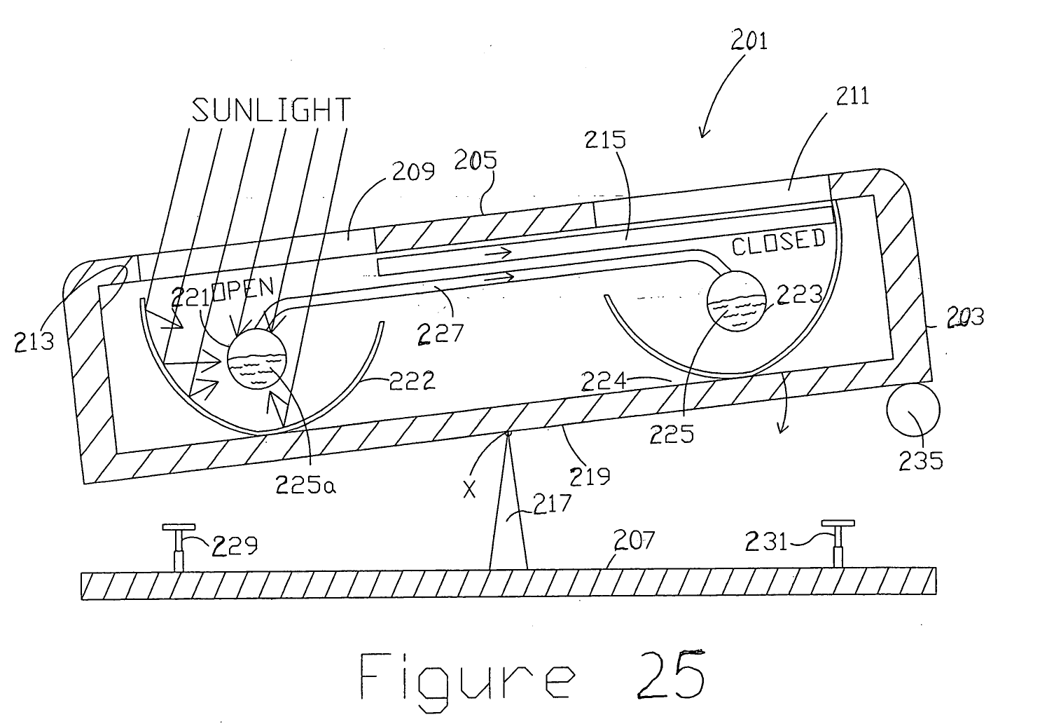

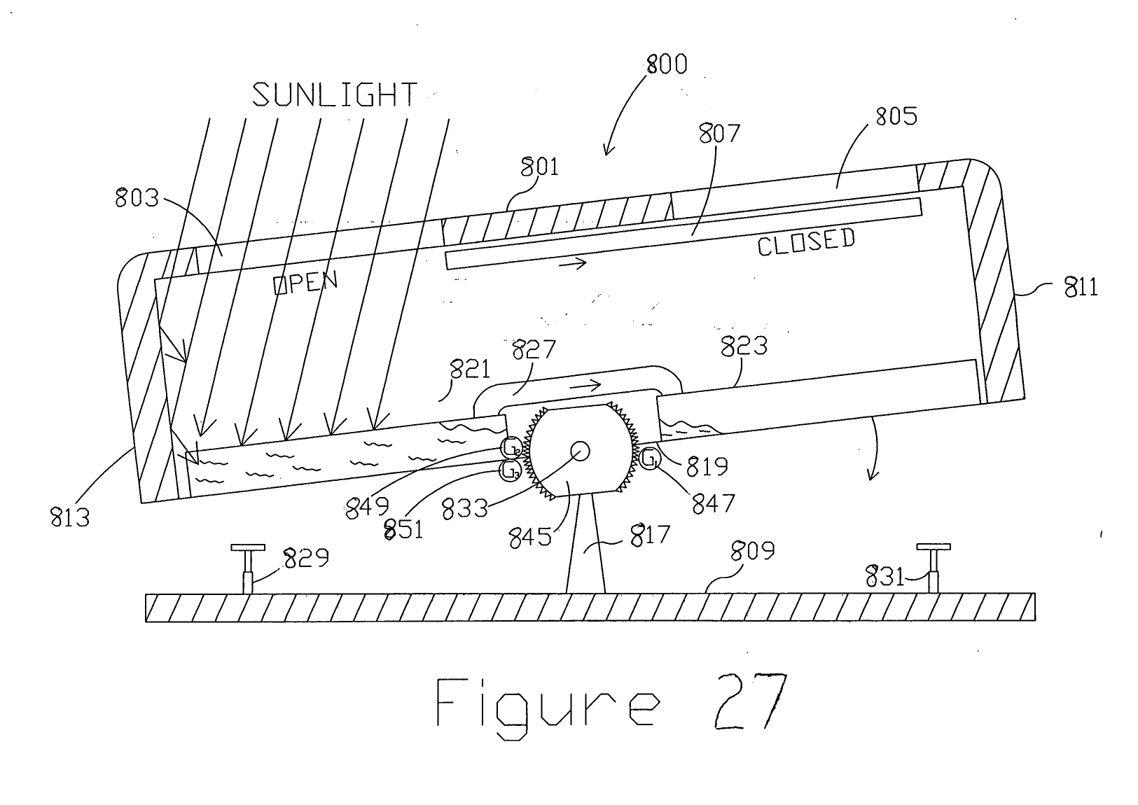

FIG. 25 is a side cut view of another preferred embodiment of a present invention reciprocating solar engine with the device 201. It is the same device shown in FIGS. 15 through 20 above as shown in FIG. 15, but with a reciprocating connector rod 235 connected to and moving with the reciprocating platform at a location away from its axis of rotation. Identical elements to the aforesaid Figures are identically numbered here and need not be repeated. Rod 235 may extend outwardly from solar engine 201 so as to allow for connection to any reciprocating drive mechanism for any purpose. Thus, it can externally be used for compression, such as with a piston, or to drive a back and forth work function (such as some well pumps) or to be converted to circular motion (such as on steam locomotion train drives), as an end user may desire.

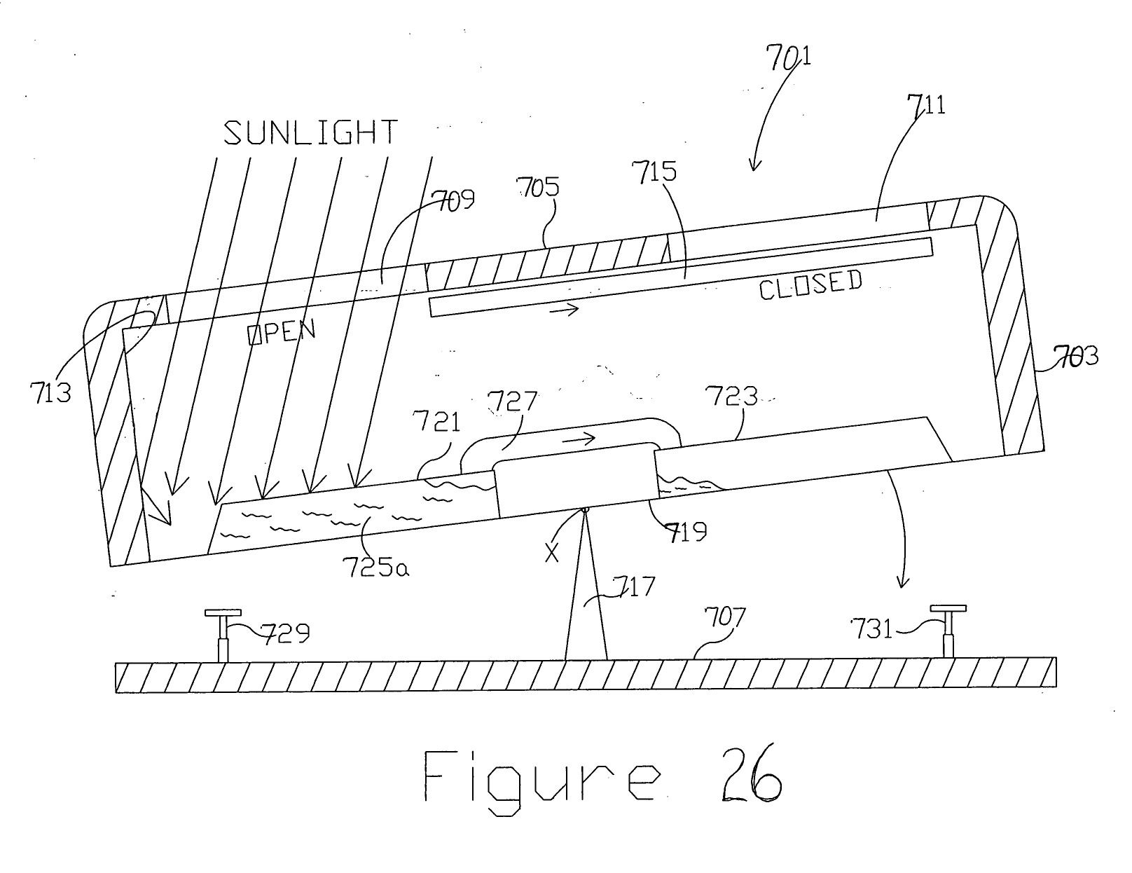

FIG. 26 shows a side cut view of another embodiment of a present invention reciprocating solar engine 701. Solar engine 701 includes a base 707, with a central fulcrum support 717 thereon. The support 717 is represented as a triangular support, but could be any form of fulcrum support means. A platform 719 is located atop central fulcrum support 717 so that platform 719 is rotatable on the central fulcrum support 717 about its axis of rotation shown as x in FIG. 26. There is a main housing 703 with side walls such as wall 713. Housing 703 also has a roof 705, with a first (left) window 709 and a second (right) window 711. The size and position of the windows are considered in conjunction with the solar heat-receiving closed containers. There is an elongated sun blocking shutter means, in this case single door 715. Door 715 is on sliders or tracks (not shown) and has a first rest position where window 709 is open and window 711 is closed, and a second rest position where window 709 is closed and window 711 is open. Housing 703 is directly or indirectly attached to platform 719 so as to move with it.

Positioned evenly on platform 719 are two solar heat-receiving closed containers. To the left of the central fulcrum support 717, on platform 719, is solar heat-receiving closed container 721 and to the right of the central fulcrum support 717, on platform 719, is solar heat-receiving closed container 723. There is a connecting means, in this case tube 727, that connects the two solar heat-receiving closed containers. They, along with platform 719, move up and down through a predetermined arc. The predetermined arc is defined by any one or more of a number of variables that may be included or are inherent in any given device. Thus, the predetermined arc is limited sometimes by the space considerations or, more specifically, by a shed or house, such as a glass roof house or greenhouse (not shown) within which the solar engine 701 may be maintained, by the height of the central fulcrum support 717 and by the length of the platform 719. Beyond that, brakes, stops, gears, shutter controls or other features may represent a bottom or top of the predetermined arc.

Contained within at least one of the two solar heat-receiving closed containers is a fluid that is capable of being at least partially vaporized to gas by solar heat and will otherwise rest in equilibrium in the container(s), possibly with some of the fluid in the gaseous state before solar heat is applied. The connecting tube is open from the left to the right containers and vice versa for transport of the vaporized fluid from the warmer container (solar heated) to the cooler container, due to gases expanding and rising. Once in the cooler container (solar shaded), the gases will at least partially condense, shifting the fluid and hence the weight of the fluid from the warmer to the cooler container. When the shutter means closes a first window and opens a second window, it shuts off most of the solar heat at the first window and allows solar heat to enter through the second window.

Referring again more specifically to FIG. 26, window 709 is open and window 711 is closed by virtue of the positioning of door 715, as shown in the Figure. Sunlight enters window 709 and not window 711. As sunlight enters window 709, it heats up container 721 and fluid 725a starts to boil over through tube 727 to container 723 where it at least partially condenses. Eventually, the weight shift will cause the right side of platform 719 to go down and the left side to go up. This is rotation of the platform about its axis of rotation x.

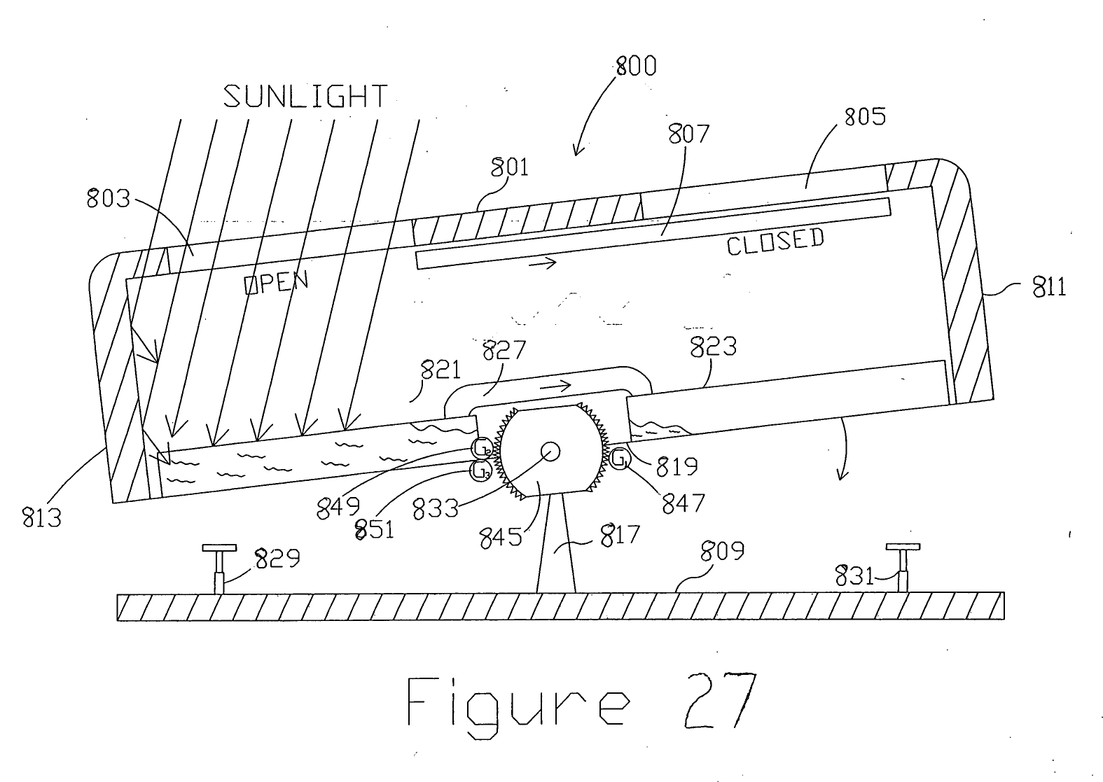

FIG. 27 is a side cut view of another preferred embodiment of a present invention reciprocating solar engine 800 with the device as shown in FIG. 26 but with a gear driving shaft take-off connected to the reciprocating platform 819 at its axis of rotation. Housing 811 has a roof 801, side walls, such as side wall 813, and is attached to the platform 819. Roof 801 has windows 803 and 805, and a central large window shuttering door 815, that keeps one window open and the other closed and versa. In FIG. 27, present invention reciprocating solar engine 800 also includes a base 809 that holds central fulcrum support 817 in place, and platform 819 is rotatably connected to or nested on or in support 817. Platform 819 has two opposing solar heat-receiving closed containers 821 and 823, connected by connecting tube 827. As shown, there is significant fluid in container 821 and a small amount of fluid in container 823. There are also two shutter control levers 829 and 831. This present invention engine 800 operates the same as the one shown in FIG. 26 above. As the platform moves through its reciprocal motion, main gear 845 rotates back and forth. When platform 819 is moving down on its right as shown by the arrow under container 823, main gear 845 rotates clockwise and it rotates gear 847 counterclockwise. Gear 847 has a take off drive to any desired operation, such as an electric generator. Gear 847 is a slip gear that will engage its takes off when gear 847 is moving counterclockwise and not when rotating clockwise, In essence, it only runs the generator in one direction (counterclockwise take off). Gear 849 works in the opposite fashion. When platform 819 is moving down on its left side, main gear 845 rotates counterclockwise and it rotates gear 849 clockwise. Gear 849 has a connecting gear 851 that rotates counterclockwise and is likewise connected to a take off drive to any desired operation, such as an electric generator. Gear 849 is a slip gear that will engage its connecting gear 851 when gear 849 is moving clockwise and not when rotating counterclockwise. In essence, it only runs the generator in one direction (counterclockwise take off from gear 851). Thus, in this embodiment, whether platform 819 is seesawing clockwise or counterclockwise, the generator will be driven and always in the same direction. Alternatively, a generator can be driven directly from the platform central axis of rotation and have a pole reversing mechanism so that no slip gear or other arrangement is necessary.

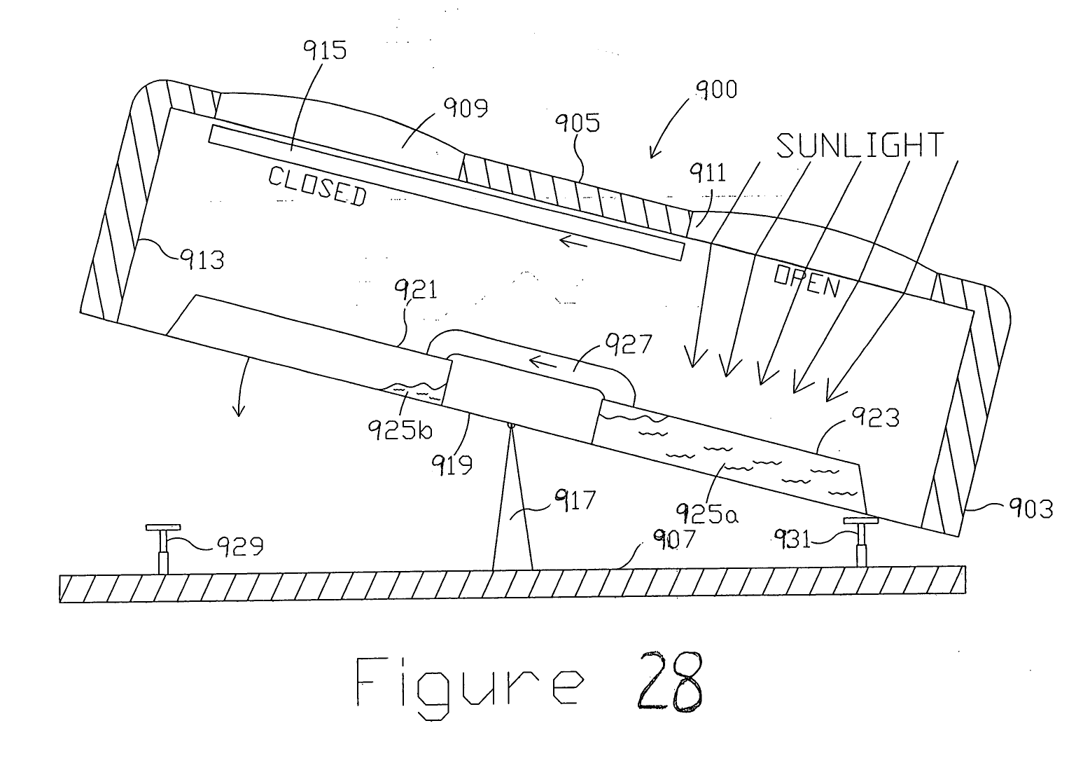

FIG. 28 is a side cut view of another preferred embodiment of a present invention reciprocating solar engine 900 with a magnifying lenses 909 and 911 in each of the respective windows of roof 905, to function as solar energy concentrators. Housing 903 has a roof 905, side walls, such as side wall 913 and is positioned on platform 919. Roof 905 has a central large window shuttering door 915, that keeps one window open and the other closed and versa. In FIG. 28, present invention reciprocating solar engine 900 also includes a base 907, a central fulcrum support 917 to rotatably support platform 919. Platform 919 has two opposing solar heat-receiving closed containers 921 and 923, connected by connecting tube 927. As shown, there is significant fluid 925a in container 923 and a small amount of fluid 925b in container 921. There are also two shutter control levers 929 and 931. The lenses will provide more concentrated solar energy, as shown in the Figure, and, in some embodiments, allow for higher boiling point fluids in the container than might be uses without the concentrator lenses. Except for the concentration of solar heat caused by the lenses 909 and 911, to either provide higher temperatures, faster boiling or both, this engine 900 operates the same as the one shown in FIG. 26 above.

To summarize, the embodiments of the reciprocating solar engine thus provide a means for powering the pump or pumps that feed seawater or other salt water into the solar evaporator. Although particular embodiments of the reciprocating solar engine have been described in detail herein with reference to the accompanying drawings, various changes and modifications may be effected therein by one skilled in the art without departing from the scope or spirit of the invention as defined in the appended claims. As examples, the drawings are shown with two windows, one left and one right. The present invention reciprocating solar engine roof could more than two or many windows without exceeding the present invention scope. The containers are, for simplicity of explanation, shown as one on each side of the fulcrum support on the platform. The present invention devices may employ a few or many connected containers and they may be connected in series, in parallel or as shown in U.S. Pat. No. 4,079,249, incorporated herein by reference.

The present invention solar desalination system with reciprocating solar engine pumps is not limited to the particular embodiments described in detail herein with reference to the accompanying drawings. Various changes and modifications may be effected therein by one skilled in the art without departing from the scope or spirit of the invention as defined in the appended claims.

What is claimed is:

1. A solar desalination system for creation of desalinated water from seawater, which comprises:
a) a solar furnace unit including a vessel for receiving and evaporating seawater to create desalinated steam and a solar energy concentrator positioned adjacent said vessel to concentrate solar energy to said vessel;
b) input means for feeding seawater to said vessel;
c) brine output means for removal of brine water bottoms from said vessel;
d) a riser pipe having a top and a bottom and being connected at its bottom to and extending upwardly from said vessel for transporting steam from said vessel, said riser pipe top positioned at a predetermined vertical height from said vessel;
e) an electric power-producing steam turbine generator positioned at a predetermined vertical height from said vessel, and connected to said top of said riser pipe for production of electric power with steam from said vessel;
f) a drop pipe having a top and a bottom, and being connected at its top to said steam turbine generator for removal of desalinated water from said steam turbine generator;
g) an electric power-producing hydroturbine generator connected to said bottom of said drop pipe for production of electric power with desalinated water from said steam turbine generator; and,
h) egress means for removal of desalinated water from said hydroturbine generator for subsequent use;
wherein said input means for feeding seawater to said vessel includes:
1) at least one pump adapted to feed seawater into said vessel, having a drive means selected from the group consisting of mechanical means, direct drive electrical means, and electrical storage means;
2) a seesawing platform having a central fulcrum support upon which said platform is moveably positioned to reciprocally rotate through a predetermined arc, said predetermined arc having a bottom, said bottom being the arc base;
3) a first solar heat-receiving closed container located on said platform on a first side of said central fulcrum support and a second solar heat-receiving closed container located on said platform on a second side of said central fulcrum support and opposite said first side;
4) at least one solar reflector located adjacent said first solar heat-receiving closed container and positioned so as to reflect solar energy from said reflector to said first solar heat-receiving closed container and at least one solar reflector adjacent said second solar heat-receiving closed container and positioned so as to reflect solar energy from said reflector to said second solar heat-receiving closed container;
5) a connecting tube, connected to said first solar heat-receiving closed container and to said second solar heat-receiving closed container;
6) a fluid contained within at least one of said first solar heat-receiving closed container and said second solar heat-receiving closed container, said fluid being evaporable from solar heat and condensable from shading from solar heat;
7) a roof located above said platform, said roof having at least two windows, at least one window of which is located above said first solar heat-receiving closed container and at least one window of which is located above said second solar heat-receiving closed container;
8) shutter means connected to said roof and movably related to said at least two windows and functionally connected thereto, said shutter means having a first rest position and a second rest position, wherein in said first rest position, said at least one window above said first solar heat-receiving closed container is open and said at least one window above second solar heat-receiving closed container is closed, and wherein in said second rest position, said at least one window above said first solar heat-receiving closed container is closed and said at least one window above second solar heat-receiving closed container is open;
9) shutter control means functionally connected to said shutter means and functionally connected to said platform such that said shutter control means activates said shutter to said first rest position when said second solar heat-receiving closed container is at its arc base, and to said second rest position when said first solar heat-receiving closed container is at its arc base; and
10) pump drive means functionally connected to said seesawing platform, said pump drive means selected from the group consisting of mechanical means, direct drive electrical means, and electrical storage means.

2. The solar desalination system for creation of desalinated water from seawater of claim 1 wherein said shutter means is selected from the group consisting of a single sliding door, doors, shutters, screens and shades.

3. The solar desalination system for creation of desalinated water from seawater of claim 1, wherein said roof is a rectangular shaped roof from a top view.

4. The solar desalination system for creation of desalinated water from seawater of claim 1, wherein said shutter controls means is selected from the group consisting of motor drive control means, mechanical control means, hydraulic control means and pneumatic control means.

5. The solar desalination system for creation of desalinated water from seawater of claim 1, wherein said first solar heat-receiving closed container and said second solar heat-receiving closed container are at least partially transparent containers.

6. The solar desalination system for creation of desalinated water from seawater of claim 5, wherein said at least partially transparent containers have transparent tops and solar heat-absorbing bottoms.

7. The solar desalination system for creation of desalinated water from seawater of claim 1, wherein said first solar heat-receiving closed container and said second solar heat-receiving closed container are selected from the group consisting of glass, metal, plastic, and combinations thereof.

8. The solar desalination system for creation of desalinated water from seawater of claim 1, further including a shaft connected to said platform proximate its center and on its axis of rotation to function as an arcuate reciprocating drive shaft.

9. The solar desalination system for creation of desalinated water from seawater of claim 1, wherein said at least two windows contain solar energy concentrating magnifying lenses.

10. A solar desalination system for creation of desalinated water from seawater, which comprises:
a) a solar furnace unit including a vessel for receiving and evaporating seawater to create desalinated steam and a solar energy concentrator positioned adjacent said vessel to concentrate solar energy to said vessel;
b) input means for feeding seawater to said vessel;
c) brine output means for removal of brine water bottoms from said vessel;
d) a riser pipe having a top and a bottom and being connected at its bottom to and extending upwardly from said vessel for transporting steam from said vessel, said riser pipe top positioned at a predetermined vertical height from said vessel;
e) an electric power-producing steam turbine generator positioned at a predetermined vertical height from said vessel, and connected to said top of said riser pipe for production of electric power with steam from said vessel;
f) a drop pipe having a top and a bottom, and being connected at its top to said steam turbine generator for removal of desalinated water from said steam turbine generator;
g) an electric power-producing hydroturbine generator connected to said bottom of said drop pipe for production of electric power with desalinated water from said steam turbine generator; and,
h) egress means for removal of desalinated water from said hydroturbine generator for subsequent use;
wherein said input means for feeding seawater to said vessel includes:
1) at least one pump adapted to feed seawater into said vessel, having a drive means selected from the group consisting of mechanical means, direct drive electrical means, and electrical storage means;
2) a seesawing platform having a central fulcrum support upon which said platform is moveably positioned to reciprocally rotate through a predetermined arc, said predetermined arc having a bottom, said bottom being the arc base;
3) a first solar heat-receiving closed container located on said platform on a first side of said central fulcrum support and a second solar heat-receiving closed container located on said platform on a second side of said central fulcrum support and opposite said first side;
4) at least one solar reflector located adjacent said first solar heat-receiving closed container and positioned so as to reflect solar energy from said reflector to said first solar heat-receiving closed container and at least one solar reflector adjacent said second solar heat-receiving closed container and positioned so as to reflect solar energy from said reflector to said second solar heat-receiving closed container;
5) a connecting tube, connected to said first solar heat-receiving closed container and to said second solar heat-receiving closed container;
6) a fluid contained within at least one of said first solar heat-receiving closed container and said second solar heat-receiving closed container, said fluid being evaporable from solar heat and condensable from shading from solar heat;
7) a housing having side walls and a roof, said housing attached to said platform so as to move therewith, said roof of said housing being located at least above said platform, said roof having at least two windows, at least one window of which is located above said first solar heat-receiving closed container and at least one window of which is located above said second solar heat-receiving closed container;
8) shutter means connected to said roof and movably related to said at least two windows and functionally connected thereto, said shutter means having a first rest position and a second rest position, wherein in said first rest position, said at least one window above said first solar heat-receiving closed container is open and said at least one window above second solar heat-receiving closed container is closed, and wherein in said second rest position, said at least one window above said first solar heat-receiving closed container is closed and said at least one window above second solar heat-receiving closed container is open;
9) shutter control means functionally connected to said shutter means and functionally connected to said platform such that said shutter control means activates said shutter to said first rest position when said second solar heat-receiving closed container is at its arc base, and to said second rest position when said first solar heat-receiving closed container is at its arc base; and,
10) pump drive means functionally connected to said seesawing platform, said pump drive means selected from the group consisting of mechanical means, direct drive electrical means, and electrical storage means.

11. The solar desalination system for creation of desalinated water from seawater of claim 10 wherein said riser pipe top and said steam turbine generator are at least 30 meters higher than said vessel.

12. The solar desalination system for creation of desalinated water from seawater of claim 10 wherein said solar energy concentrator is selected from the group consisting of a linear parabolic solar concentrator, a parabloid solar concentrator and plural mirror solar concentrator.

13. The solar desalination system for creation of desalinated water from seawater of claim 12 wherein said solar energy concentrator is moveably mounted, and includes solar tracking means adapted to move said solar energy concentrator to follow the sun.

14. The solar desalination system for creation of desalinated water from seawater of claim 10 wherein said system further includes:
i) auxiliary heating means proximate said vessel and adapted to heat said vessel to assist said solar furnace.

15. The solar desalination system for creation of desalinated water from seawater of claim 14 wherein said auxiliary heating means is adapted to operate when solar power is insufficient to evaporate seawater in said vessel.

16. The solar desalination system for creation of desalinated water from seawater of claim 14 wherein said auxiliary heating means is an electric heating means that is powered from at least one of said generators.

17. The solar desalination system for creation of desalinated water from seawater of claim 10 wherein said riser pipe includes at least one booster heater.

18. The solar desalination system for creation of desalinated water from seawater of claim 17 wherein said at least one booster heater is selected from the group consisting of a solar heater, a heat exchange heater, an electric heater and combinations thereof.

19. The solar desalination system for creation of desalinated water from seawater of claim 10 wherein said egress means includes heat exchange cooling means.

20. The solar desalination system for creation of desalinated water from seawater of claim 10 wherein said system includes an elevated storage tank connected to and downstream from said steam turbine generator and connected to said drop pipe, adapted for storage and controlled release of desalinated water to provide water and power when said solar furnace unit is not producing water and electricity.
